(19) United States
(12) Patent Application Publication
(10) Pub. No.: US 2014/0239018 A1
(43) Pub. Date: Aug. 28, 2014

(54) SPRAY/FOAM DISPENSERS WITH IMPROVED VENTING ("OPTIMUS")

(71) Applicant: DISPENSING TECHNOLOGIES B.V., Helmond (NL)

(72) Inventors: Wilhelmus Johannes Joseph Maas, Someren (NL); Dominicus Jan van Wijk, Helmond (NL); Paolo Nervo, Duizel (NL); Petrus Lambertus Wilhelmus Hurkmans, Someren (NL); Aaron Haleva, Oakhurst, NJ (US)

(73) Assignee: DISPENSING TECHNOLOGIES B.V., Helmond (NL)

(21) Appl. No.: 14/073,814

(22) Filed: Nov. 6, 2013

Related U.S. Application Data
(60) Provisional application No. 61/723,045, filed on Nov. 6, 2012.
(60) Provisional application No. 61/810,694, filed on Apr. 10, 2013.

(51) Int. Cl. B05B 11/00

(52) U.S. Cl. CPC B05B 11/3042
USPC 222/383.1; 29/890.1; 222/23

(57) ABSTRACT

In exemplary embodiments of the present invention, various new generation dispensing devices can be provided. Such devices are vertically aligned, provide greater than 1.0 cc per piston stroke, and can involve a range of sprayer heads and sprayer/foamer systems incorporating such heads. Such novel sprayer heads can include a novel stretched piston, or, for example, the standard separate piston and piston chamber configuration. By using integration of parts, and a novel dome valve, exemplary sprayers are more easily manufactured, and have better operating properties. Finally, pre-compression is such novel valves is supplied by a novel dome valve with binary behavior, and minimal hysteresis.

### CROSS-REFERENCE TO RELATED APPLICATIONS

This application claims the benefit of U.S. Provisional Patent Applications Nos. 61/723,045, entitled NEW GENERATION SPRAY/FOAM DISPENSERS, WITH AND WITHOUT BUFFERING SYSTEMS (“NGOP”), filed on Nov. 6, 2012, and 61/810,694, entitled SPRAYER HEAD WITH IMPROVED VENTING (“OPTIMUS”), filed on Apr. 13, 2013, the disclosure of each of which is hereby fully incorporated herein by reference.

### TECHNICAL FIELD

The present invention relates to dispensing technologies, and in particular to a new generation of novel sprayers/foam dispensers of various types with integrated parts, smaller footprint and novel pre-compression valves.

### BACKGROUND OF THE INVENTION

Liquid dispensing devices such as spray bottles are well known. Some offer pre-compression so as to insure a strong spray when the trigger is pulled and prevent leakage. Sprayers and foamers can be easily manufactured and filled, and are often used to dispense cleaners of all types, for example. Vertical sprayers have been a desideratum in the market. However, it has been difficult to create a vertically aligned sprayer that can output greater than 1.00 cc per stroke (i.e., having a piston chamber volume greater than 1.0 cc). It has further been difficult to create a sprayer of minimal part count.

Additionally, sprayers generally now exhibit some form of pre-compression. However, if a pre-compression valve has variation in opening and closing pressures, its performance is not binary, and this can cause dripping.

What is needed in the art are vertical sprayers having minimal part counts, and thus offering better cost attributes, as well as substantial displacement volume per stroke. What is further need in the art are better valves for more precise control of pre-compression, with minimized differences between opening and closing pressures.

### SUMMARY OF THE INVENTION

In exemplary embodiments of the present invention, various new generation dispensing devices can be provided. Such devices are vertically aligned, provide greater than 1.0 cc per piston stroke, and can involve a range of sprayer heads and sprayer/foamer systems incorporating such heads. Such novel sprayer heads can include a novel stretched piston, or, for example, the standard separate piston and piston chamber configuration. By using integration of parts, and a novel dome valve, exemplary sprayers are more easily manufactured, and have better operating properties. Finally, pre-compression is such novel valves is supplied by a novel dome valve with binary behavior, and minimal hysteresis.

### BRIEF DESCRIPTION OF THE DRAWINGS

It is noted that the U.S. patent or application file contains at least one drawing executed in color (not applicable for PCT application). Copies of this patent or patent application publication with color drawings will be provided by the U.S. Patent Office upon request and payment of the necessary fee.

FIG. 1 illustrates the characteristics of Assignee's/Applicant's OnePak™ technology, and the benefits of pre-compression sprayers;

FIGS. 2-3 illustrate various pre-compression technologies;

FIG. 4 illustrates an exemplary lock-out system for underpressure systems, such as sprayers according to exemplary embodiments of the present invention;

FIG. 4A depicts examples of lock-out “keys” to uniquely connect a bottleneck with a dispensing head, according to exemplary embodiments of the present invention;

FIGS. 5-6 illustrate a novel pre-compression dome valve according to exemplary embodiments of the present invention;

FIG. 5:

FIG. 7 illustrates adaptations and modifications that can be made to the novel dome valve of FIGS. 5-6;

FIGS. 8-11 provide details of the operation of the dome valve of FIGS. 5-6;

FIGS. 12 through 14 provide details and component parts of an exemplary novel “Optimus” sprayer according to exemplary embodiments of the present invention;

FIG. 15 depicts a hydraulic scheme for the sprayer of FIGS. 12-14;

FIG. 16 depicts vertical architecture and assembly of the sprayer of FIGS. 12-14;

FIG. 17 illustrates a novel venting technique that allows venting via a vertically oriented piston bore;

FIGS. 18-24 illustrate part integration in exemplary sprayers, thus reducing manufacturing cost and time;

FIG. 25 depicts a tamper-proof feature integrated in an exemplary adapter shroud, according to exemplary embodiments of the present invention;

FIG. 26 illustrates various attachment possibilities between sprayer head and bottle or reservoir;

FIG. 27 illustrates an exemplary lock-out mechanism;

FIGS. 28-29 illustrate a novel stretch mold technology and various exemplary uses thereof, according to exemplary embodiments of the present invention;

FIG. 30 depicts exemplary sprayers with separate and stretch pistons, respectively, according to exemplary embodiments of the present invention;

FIG. 31 illustrates an exemplary stretched piston sprayer with the trigger fully out according to exemplary embodiments of the present invention;

FIG. 32 depicts the stretched piston sprayer of FIGS. 30 and 31 with the trigger in an intermediate position;

FIG. 33 illustrates the stretched piston sprayer of FIGS. 1 through 3 with the trigger pulled all the way in (back) according to exemplary embodiments of the present invention; and

FIGS. 34 and 35 provide details of the exemplary stretched piston sprayer of FIG. 30, and its unique venting feature.

### DETAILED DESCRIPTION OF THE INVENTION

In exemplary embodiments of the present invention, various novel sprayers and related dispensing devices are presented. The sprayer heads shown can, in general, work with both standard bottles or reservoirs as well as the “bag within a bag” Flair® technology developed and provided by Dispensing Technologies B.V. of Helmond, The Netherlands. The “bag within a bag” Flair® technology, which causes the inner container to shrink around the product, thus obviates headspace or air bubbles in the inner container. Because in Flair® technology the pressure applied to the inner bag results from a pressurizing medium, often atmospheric pressure vented between said inner and outer containers, venting of the liquid container is not required. Of course, whenever a product is dispensed from an inner bag in a Flair system, which shrinks to the remaining volume of the product as it dispenses, then the pressure has to be equalized in the gap between the outer container and the inner container. This can be done, for example, using a medium, such as, for example, air, whether at atmospheric pressure or higher. This can easily be done by venting that gap to ambient air. This can be done, for example, by providing a vent, such as, for example, on the bottom of the Flair container, or at any other convenient position of the outer container. In some exemplary embodiments such a vent is moved to the sprayer head itself, via a novel outlet valve.

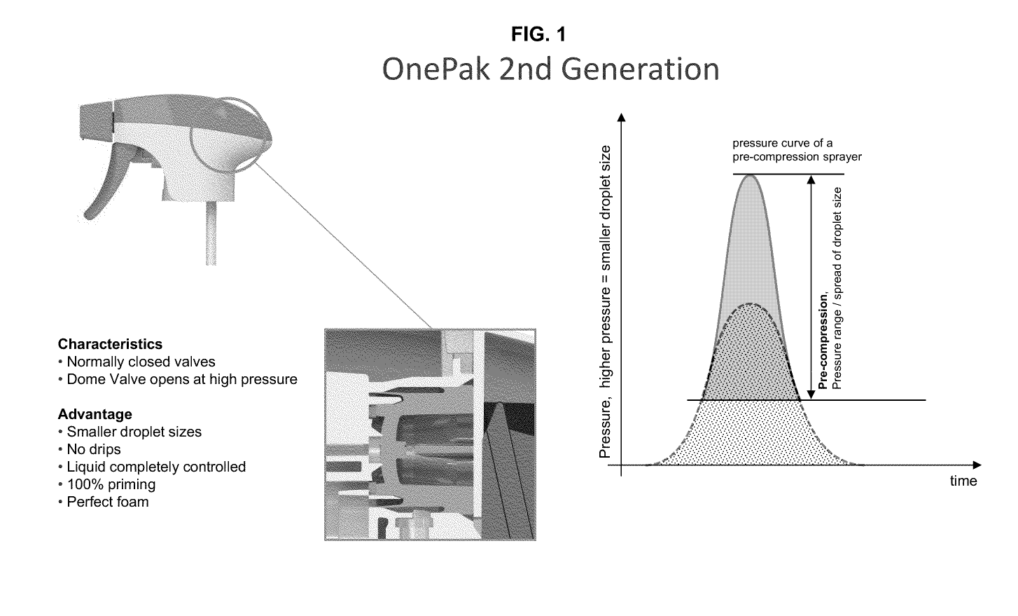

FIG. 1 illustrates features of a conventional pre-compression sprayer. The right side image of FIG. 1 depicts the pressure v. time curve of a pre-compression sprayer. Notably there is a larger range of pressures that are output from a pre-compression sprayer relative to a sprayer that does not use precompression. As noted in FIG. 1, a pre-compression sprayer has normally closed valves. The outlet valve therefore only opens at a pre-determined pressure, known as the “cracking pressure”. The displacement volume between inlet and outlet valve of the pump is to become zero during a compression stroke. If it does not, the pump cannot prime. When the piston is actuated by a user, the sprayer only starts dispensing when the liquid pressure is above the cracking pressure of the outlet valve. Therefore, slow actuation of the pump will give no drips because the pump starts dispensing at a higher pressure. Here in a pre-compression sprayer, performance is less dependent upon the user's operating behavior than in the case of a conventional sprayer without pre-compression.

Advantages of a pre-compression sprayer include: smaller droplet sizes, no drips, the fact that the liquid is completely controlled, 100% priming, and the ability to dispense perfect foam.

### Pre-Compression Technologies and Valves

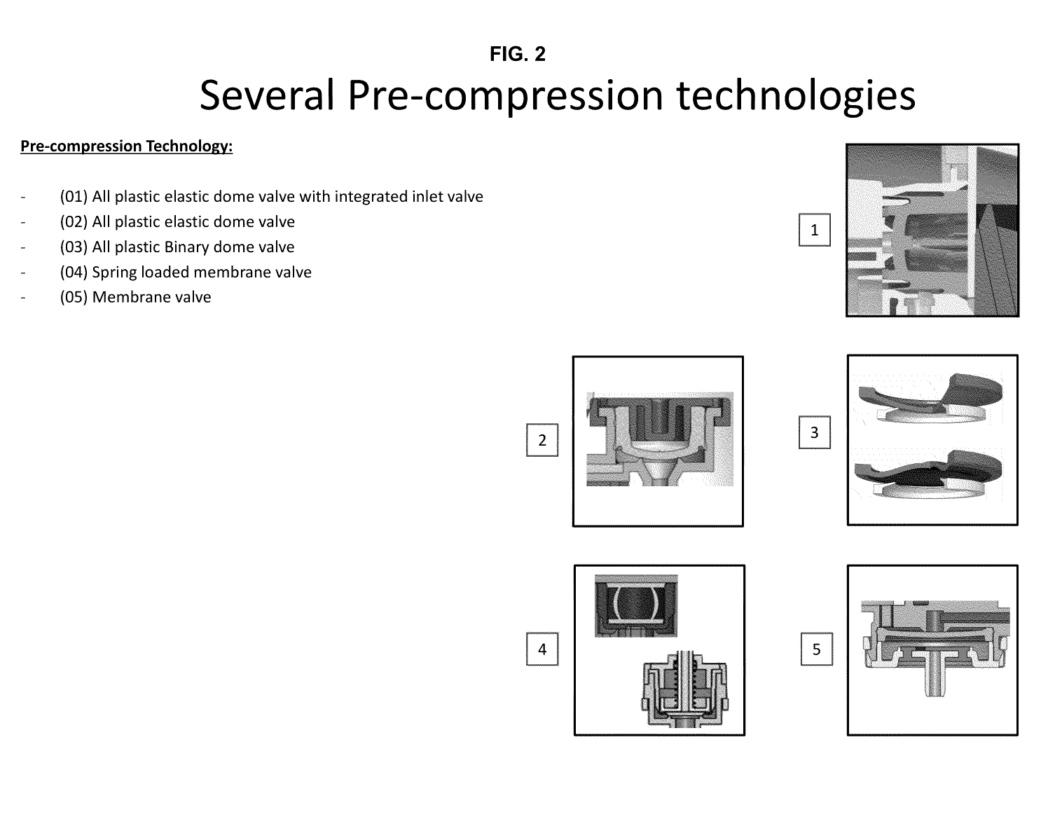

FIG. 2 illustrates various pre-compression technologies which can be used for the dome valve, or pre-compression valve, in a sprayer. Pre-compression technology can be used in all kinds of dispensing applications. For example, floor mops, window washers, sprayers, etc. Pre-compression technology can be used in a wide pressure-range of dispensing applications, from low to high pressures. Pre-compression valves can be made in all types, configurations, and combinations of configurations and materials, for example, as shown in FIG. 2: (1) All plastic elastic dome valve with integrated inlet valve; (2) All plastic elastic dome valve; (3) All plastic binary dome valve; (4) Spring loaded membrane valve; and (5) Membrane valve.

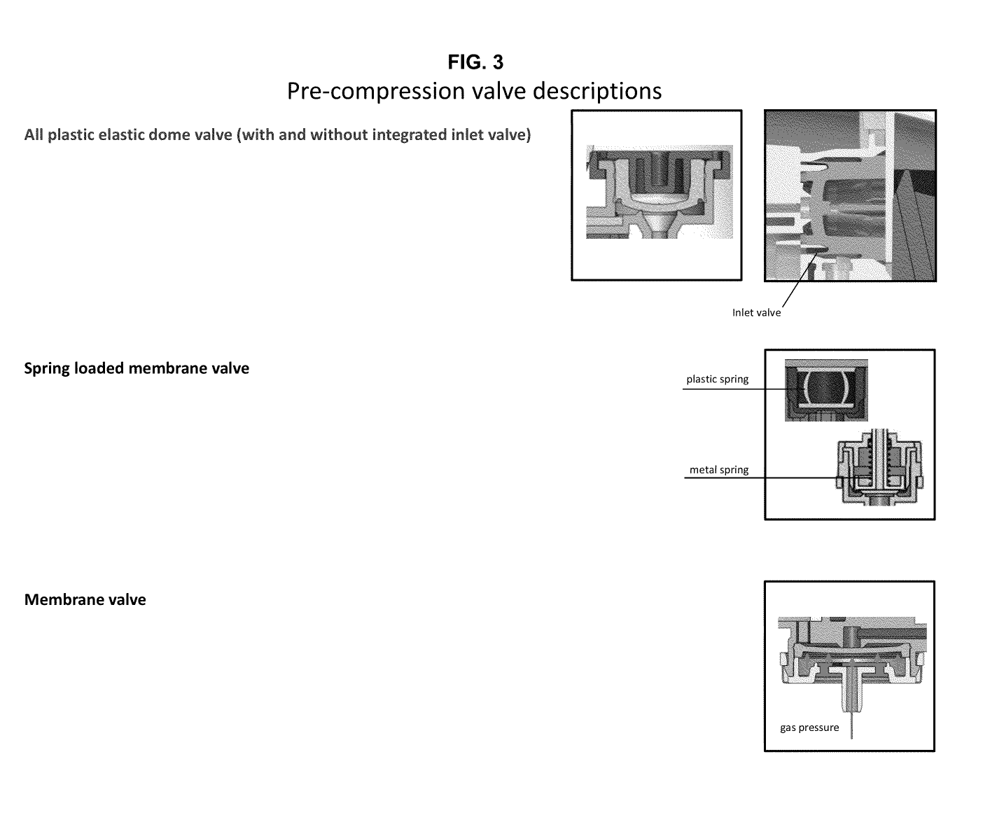

FIG. 3 illustrates various types of pre-compression valves. With reference thereto, there is, for example, an all plastic elastic dome valve (with and without integrated inlet valve). Here the closing force of the valve, and therefore the force needed to open the valve, is determined by the elasticity of the material and the pre-tension in assembly. Additionally, there is shown a spring loaded membrane valve. Here the closing force of the valve, and therefore the force needed to open the valve, is determined by the force of the metal or plastic spring placed behind the membrane. The membrane is thus the seal between spring and liquid. Finally, as shown at the bottom of FIG. 3, there is a membrane valve. Here the closing force of the valve, and therefore the force needed to open the valve, is determined by a gas pressure behind the membrane, as shown. The gas pressure acts like a spring. The membrane is the seal between gas and liquid.

### Lock Out

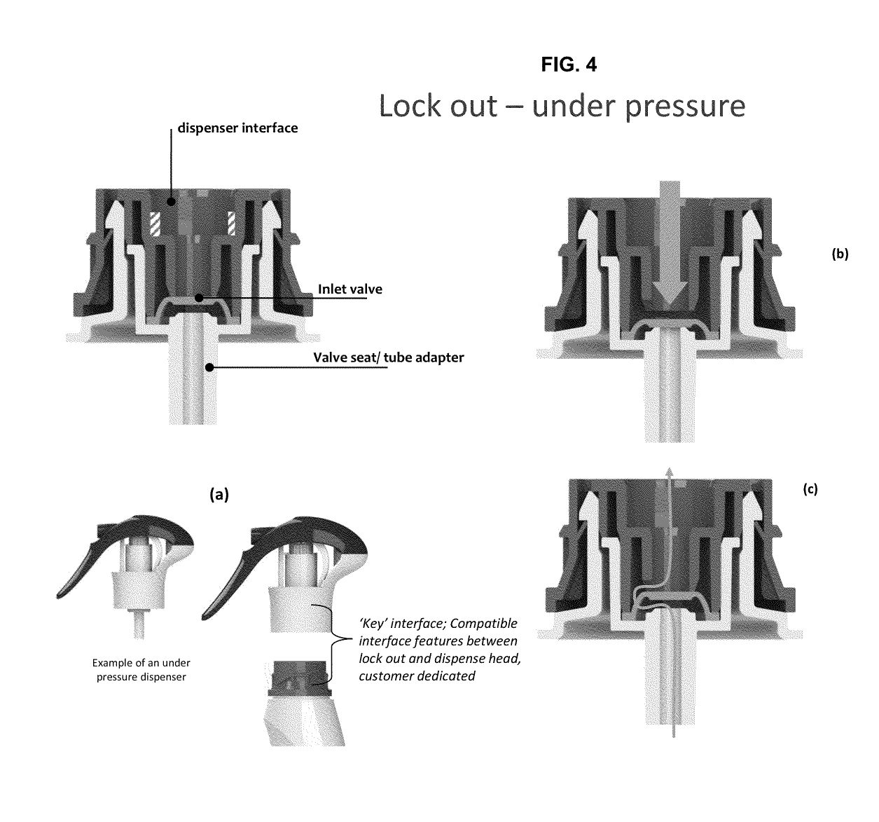

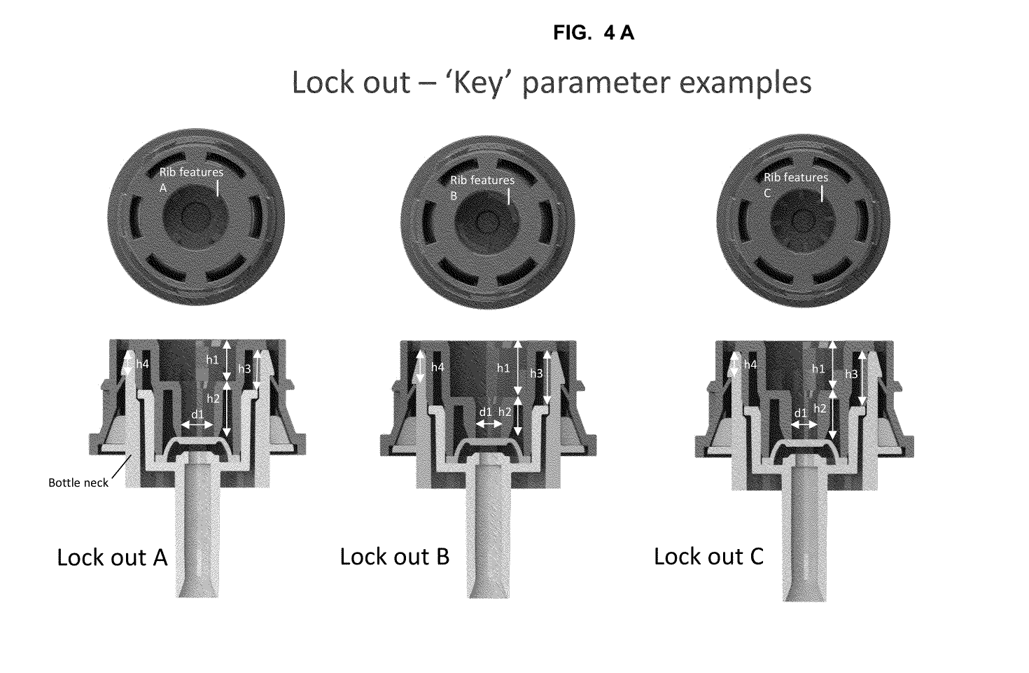

FIG. 4 illustrates exemplary lock-out systems that can be used in exemplary embodiments of the present invention. A lock out system prevents a different supplier's bottle from being used with a given sprayer head. In particular, FIG. 4 illustrates lock-out systems for underpressure sprayers, such as the Optimus sprayer described below. The lock-out uses the dispenser interface at the top of an exemplary bottle, and integrates an inlet valve in such an interface. As shown, in a lock-out for an under pressure sprayer or system, the inlet valve can be normally open in the output direction of the bottle. The passage way to the bottle is closed during a compression stroke, or when refilling is attempted.

Removing the valve disables the use of the bottle, since the valve also acts like the inlet valve of the pump. The passageway to the dispenser is open when the valve rests against the upper valve seat when liquid enters the pump by an under pressure in the bottle. The upper valve seat has openings, providing for the passage of liquid. There is a ‘Key’ interface, a set of compatible interface features between the lock out interface and a dispensing head, which is customer dedicated.

FIG. 4(c) illustrates an example of an under pressure dispenser. Here the passageway to the dispenser is open when the valve rests against the upper valve seat when liquid enters the pump by under pressure. As shown, the upper valve seat has openings, providing the passage of liquid.

In exemplary embodiments of the present invention, a sprayer manufacturer, provides, owns and controls the lock-out system. A unique key is given to a customer to protect against competitors within his own field of use during a licensing period. The lock out prevents competitors from selling products compatible with the dispenser, preventing consumers to refill the bottle with competitor products. The lock out thus acts as an interface between a bottle and the dispenser.

As noted, the lock out incorporates the inlet valve of the pump system; this means that the dispenser cannot operate without being connected to the lock out. The lock-out has unique ‘key’ features, dedicated to a customer. The geometry of the lock-out can be changed to create these unique features. For example: the diameter, depth and added geometries. Thus, in general, the lock out geometry has to match the interfacing geometry of the dispenser in order to be connected.

It is noted that to have a dispensing system which is a 100% lock out of competitors, a Flair bottle is to be used. In this case the dispenser does not have to vent a Flair system, or a closed bag within a bag, or container within a container, system needs no venting (and no headspace in the inner container), and the bottle cannot be refilled by drilling a hole in the bottle wall. Any tampering disables the dispensing system.

As shown in FIG. 4, when disconnecting the dispenser from the bottle, the lockout system remains connected to the bottle and the valve closes. The dispenser, of course, is removed from the neck of the bottle. As shown in FIG. 4, there can be various parameters used to create multiple unique lockout interfaces. These can include, for example, (1) length of dispenser stem, (2) dedicated blocking geometry and (3) size of sealing diameter, to name a few. As shown, a unique lockout interfacing is needed, for example to (1) prevent competitors from selling refills and to (ii) prevent the use of the same dispenser for both non-hazardous and hazardous liquids such as, for example, both inert cleaning fluids and bleach. As shown in FIG. 4, although the depicted example has three unique locking parameters, one can easily use 5, 6, 7 or even 10 different parameters that uniquely define a connection between a bottle and the sprayer head that allows that sprayer head to dispense the liquid in that bottle. For example, the valve can operate as the lower valve (inlet valve) of a pump. Therefore, when it does not fit, one cannot achieve an underpressure via the pump.

FIG. 4A illustrates various “key” parameter examples. As shown in the leftmost image, heights h3 and h4 can be used to lock a custom bottle to a custom lock out system. Diameter d1, heights h1, h2, and unique rib feature geometry can be used to lock a dispensing head to a custom lock system

The dispenser has to be similarly fitted with matching geometries. Thus, when the rib features of the lock out, and contra rib features on the dispenser do not correspond, a combination cannot be made, and no dispensing is possible. Thus, for example, a dispenser geometry matching h1 of exemplary Lock out B (middle image of FIG. 4A) cannot fit to h1 of exemplary Lock out A (leftmost image in FIG. 4A). Similarly, a dispenser geometry matching d1 of example Lock out A cannot fit to d1 of example Lock out B, etc. The same goes for rib features, for example rib features A, B and C, and other distinguishing dimensions.

### Novel Dome Valve

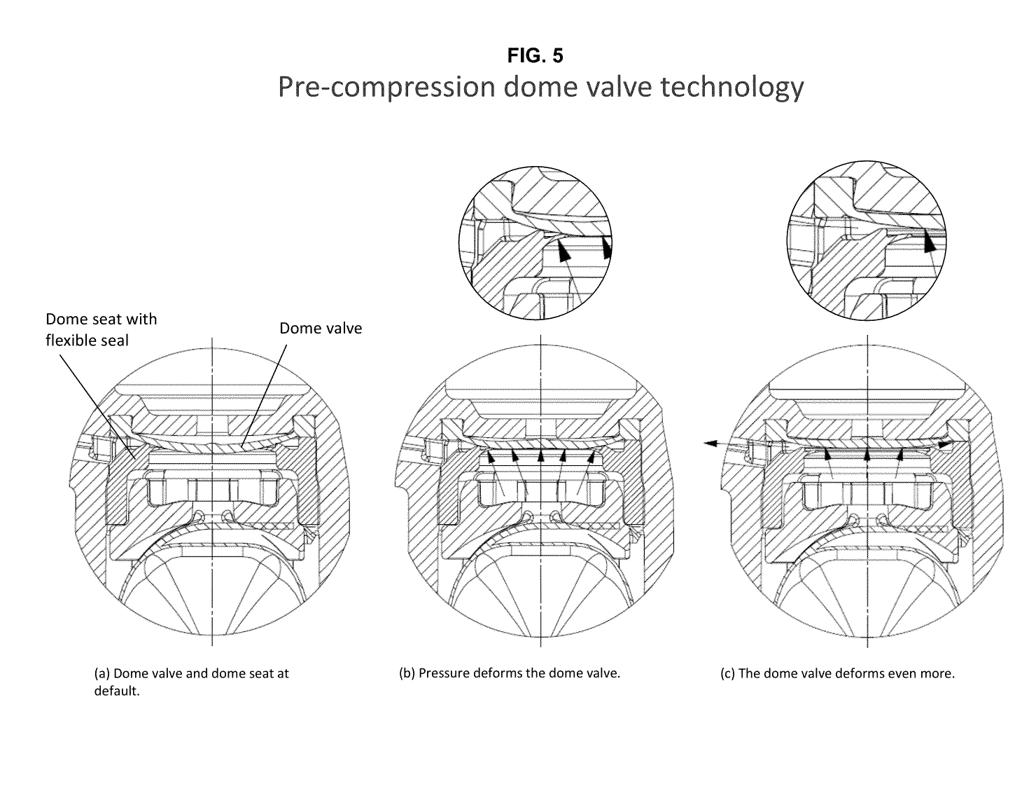

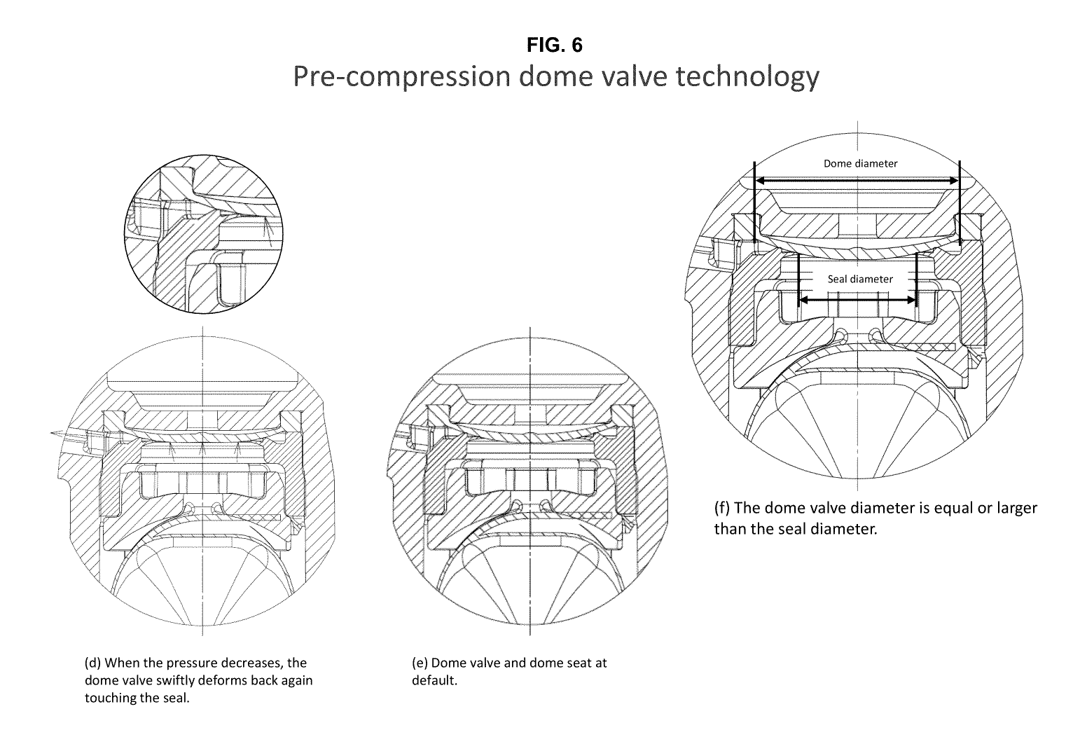

FIGS. 5-11 present details of a novel dome precompression valve. The main inventive goal was to create a dome valve having a more binary behaviour. I.e., a more instantaneous opening and closing of the dome with as little as possible difference in these pressures (small hysteresis). For this purpose a dome valve was created which interacts with a flexible seal. FIGS. 5 and 6 show six snapshots of the dome valve in operation (lower tier of images) and magnified portions of the key areas of the images (upper tier of images). With reference thereto, these are as follows:
FIG. 5:
(a). Dome valve and dome seat at default. The dome seat seal rests against the dome valve with pre-tension;
(b). Pressure deforms the dome valve, pushing it upwards. The seal of the dome seat flexes but still rests against the dome valve;
(c). Under rising pressure, the dome valve deforms even more, becoming nearly flat. The seal valve (thin protrusion of inner ring of dome seat) has flexed to default position and no longer rests against the dome valve. An opening between the seal and the dome valve is thus created, as shown;
FIG. 6:
(d). When the pressure decreases, the dome valve swiftly deforms back again, touching the seal. Dispensing stops instantaneously, as the liquid cannot pass any longer;
(e). Dome valve and dome seat back at default position. The dome seat seal rests against the dome valve with pre-tension; and
(f). The dome valve diameter “Dome diameter” in FIG. 6, is equal to or larger than the seal diameter “Seal diameter” in FIG. 6. A larger difference increases the hysteresis, as, in such case, the opening pressure will be higher than the closing pressure of the dome valve.

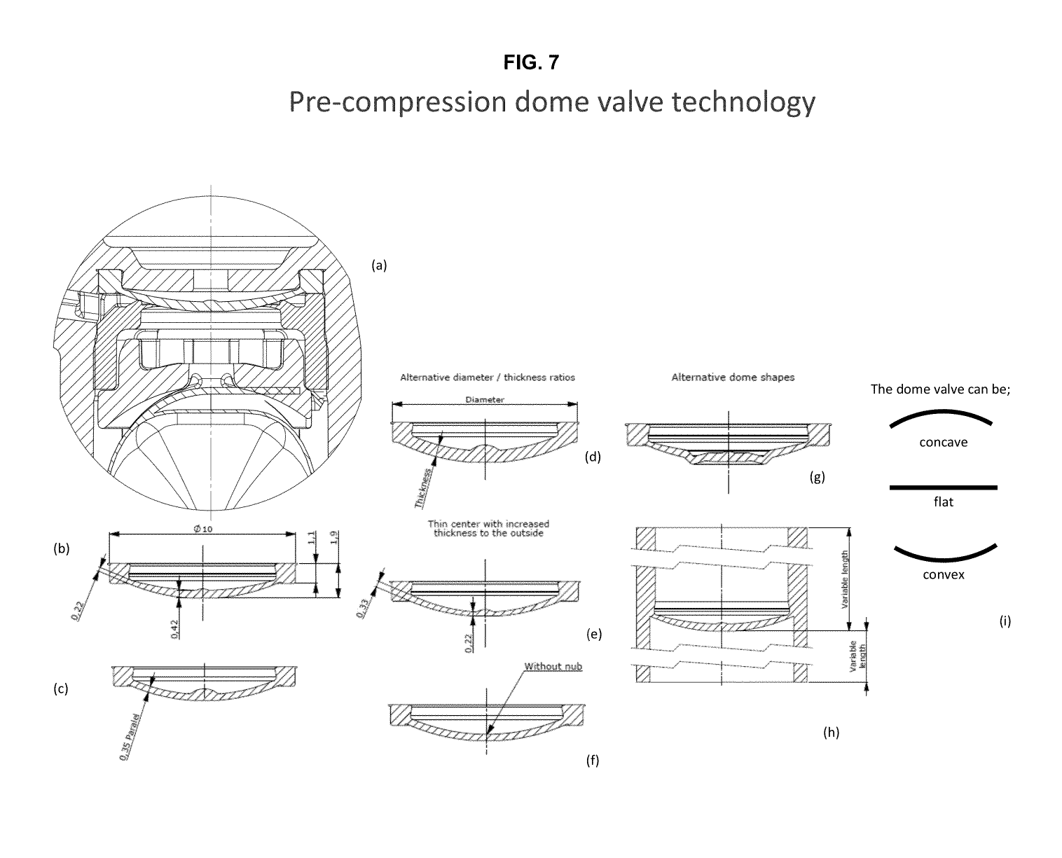

As shown in the various views of FIG. 7, the dome and seal can be changed in order to adapt or implement properties such as opening and closing pressure, and flow. Changes that can be made can include, for example, wall thickness, diameter, material, height, whether to include a “nub”, and/or curviness (convex, flat, concave) of the dome. The material of the dome valve can be, for example, a semi-crystalline plastic such as a PP or PE grade. This is suitable for a wide range of liquids. If the dome needs specific properties, such as a higher flexible modulus, other materials can be used, such as POM grades. However, use of POM limits compatibility with liquids, as bleach, for instance, is not compatible with POM. Various shapes, sizes and executions of the dome valve can exist, such as are shown in FIG. 7, for example. In these examples, the dimensions are merely exemplary, and understood not to be limiting at all.

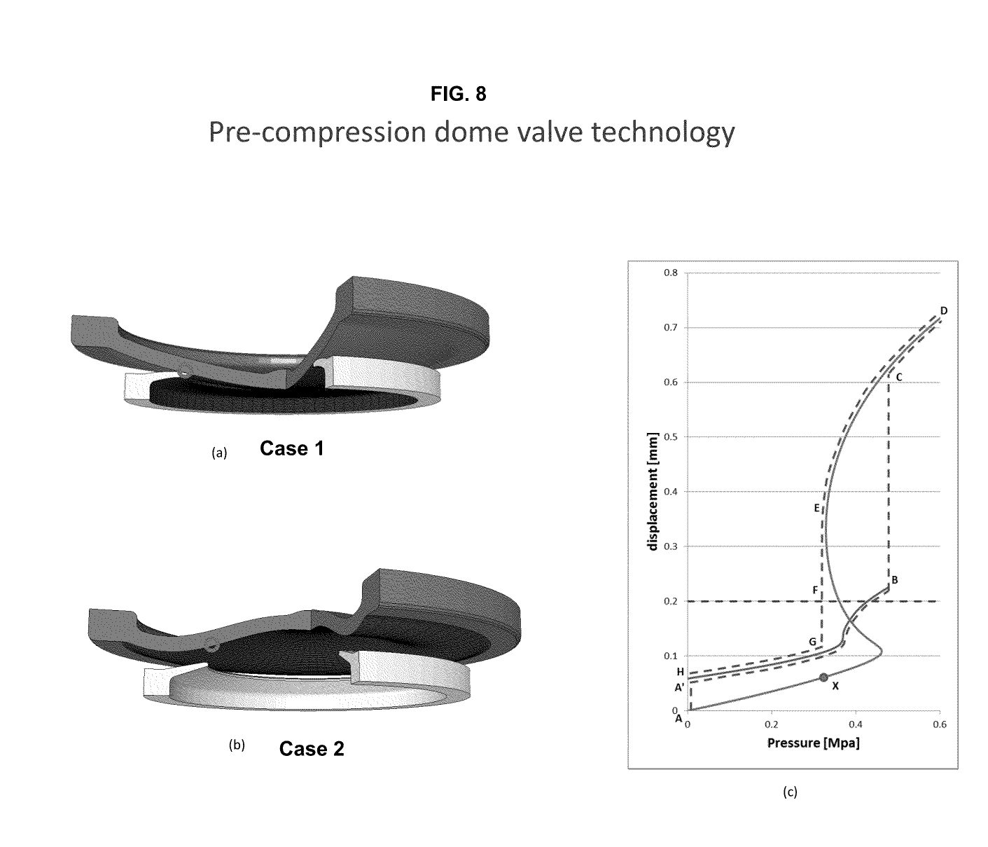

FIG. 8 depicts a graph of displacement versus pressure, and two load cases, for an exemplary dome valve. The graph shows the displacement of the point of the dome which is in contact with the seal. The green line (that touches at Point A) represents the dome, and the blue line (that touches at Point A′) represents the seal when it interacts with the dome. There are two possible load cases:

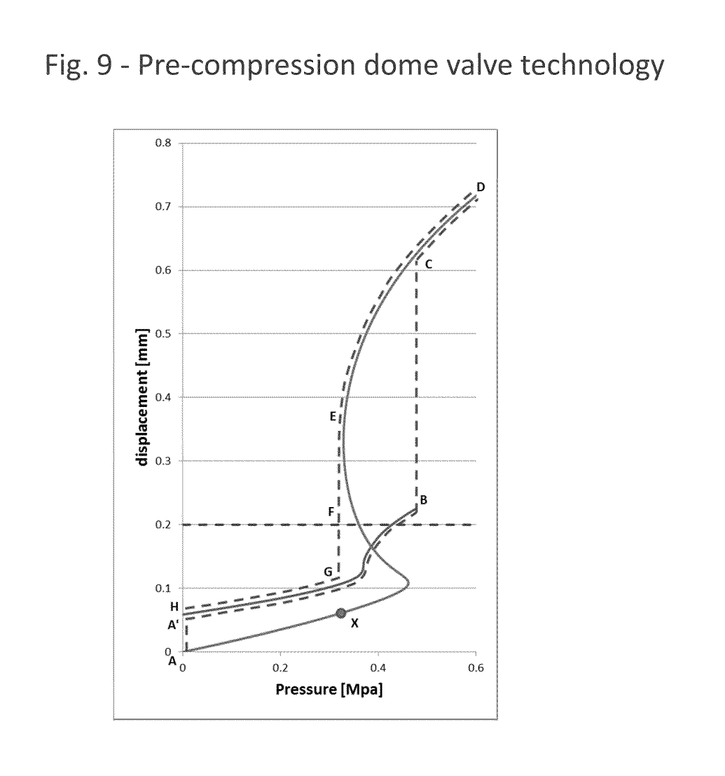

Case 1—Closed situation where only part of the dome is pressurized and there is a pressure difference over the seal (solid blue line in graph)
Case 2—Open situation where the complete dome is pressurized and there is no pressure difference over the seal (solid green line in graph). The dashed blue line (horizontal line at displacement=0.2 mm) is the position of the seal in the “open” situation. FIG. 9 shows the graph of FIG. 8 in a more magnified way.

With reference to the graph of FIG. 9, there are various operational states of the valve:

A-A′ The seal is pre-tensioned by moving the seal 0.2 mm relative to the dome;
A′-B Pressure buildup gives a displacement of the dome accompanied with the seal up to the point B. At this point the contact force between the dome and the seal becomes zero and the valve opens;
B-C When the valve is open the behaviour of the dome changes due to the fact that the seal is no longer pushing against the dome and the pressurized section on the dome has become larger. The seal which is no longer pressurized will go back to its neutral position at 0.2 mm while the dome jumps to 0.62 mm. This gives a sudden opening of 0.42 mm over a theoretic infinitesimal small pressure step. This binary behaviour is necessary to make sure that the pressure drop over the valve is small enough to have a negligible effect on the flow through the nozzle;
C-D When the pressure increases further the displacement of the dome will increase. (this can be limited by establishing a contact between the dome and another part);
D-E When the pressure decreases the dome will become instable at point E. At this point the distance between the seal and the dome is still 0.35−0.2=0.15 mm. This opening is necessary to make sure that the pressure drop over the valve is small enough to have a negligible effect on the flow through the nozzle;
E-F Due to the instability the displacement of the dome will decrease instantaneously and the seal (in neutral position) comes into contact with the dome at point “F”. The neutral position of the seal has to be between point “E” and “X” to ensure the functionality of the seal;
F-G When the seal is in contact with the dome the “closed” situation is established and the seal will accompany the dome to point G. This will happen instantaneously as well; and
G-H Further decrease in pressure will result in gradual decrease in displacement.

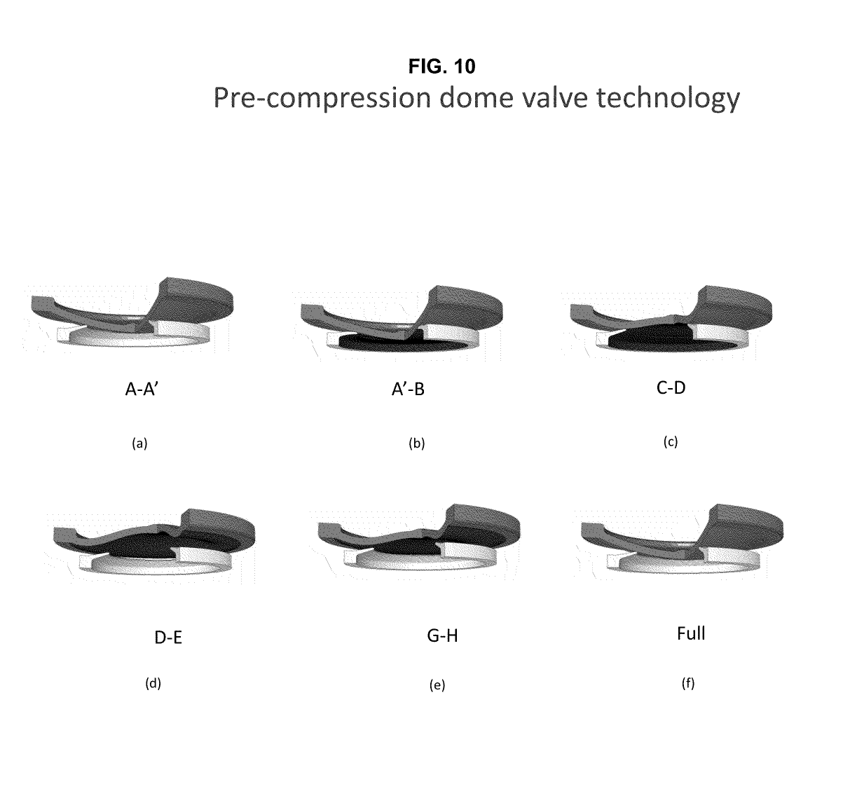

FIG. 10 illustrates the dome shape and configuration during some of the above-identified operational states.

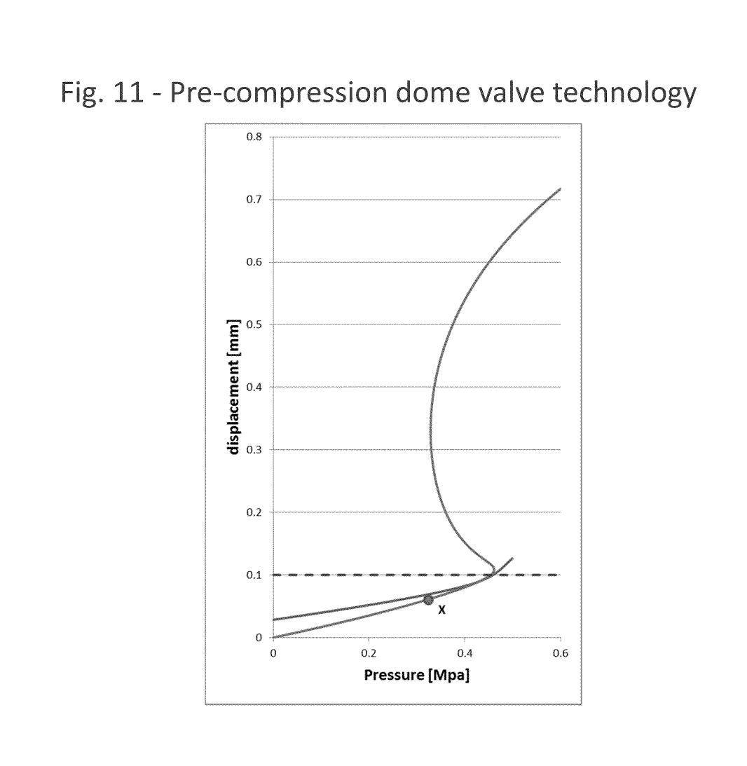

Finally, FIG. 11 illustrates how, over time, pre-stresses in the seal and dome will relax. This will particularly change the “closed” behaviour of the seal and dome. In the graph presented in FIG. 11, the effect of a 50% relaxation is presented. It shows that the valve will continue to function as described in the previous slides.

### Optimus Sprayer

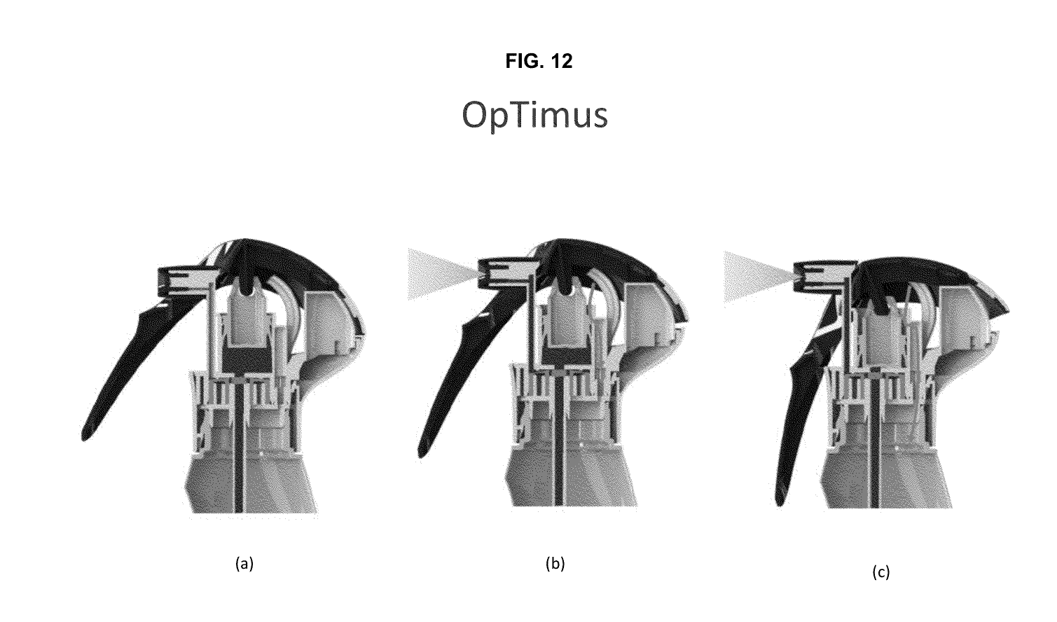

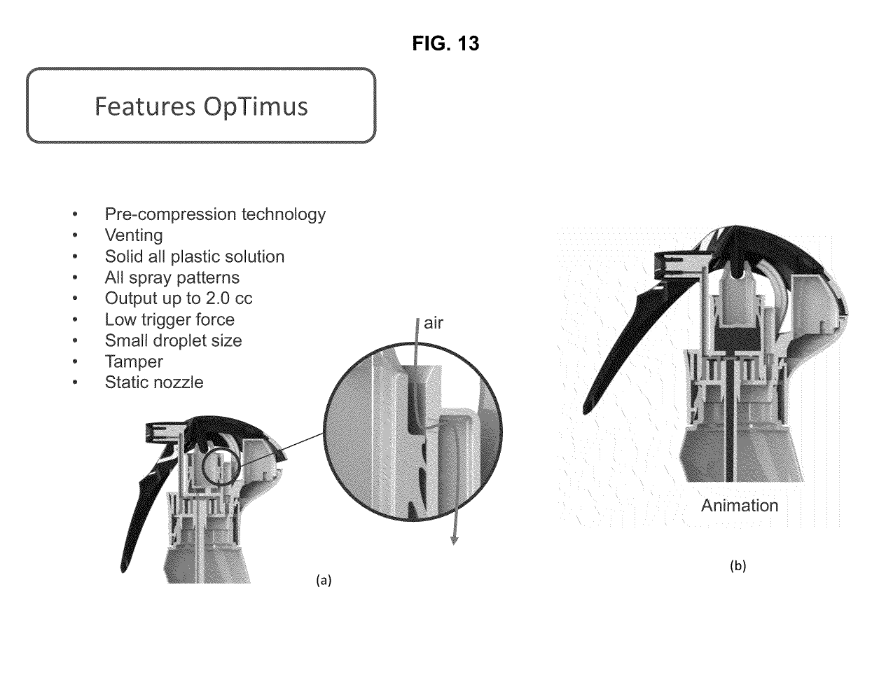

FIGS. 12 through 14 provide details and component parts of an exemplary novel “Optimus” sprayer according to exemplary embodiments of the present invention.

The Optimus sprayer has the following key features:
Vertical oriented architecture and assembly
Piston in line with the Dome valve
Venting in vertical piston bore
Part integration=less parts:
Nozzle and trigger
Body and springs
Dome valve and inlet valve
Adapter shroud and tamper
Tamper evident
Lock out option
Stretched piston option (an integration of piston and bore)

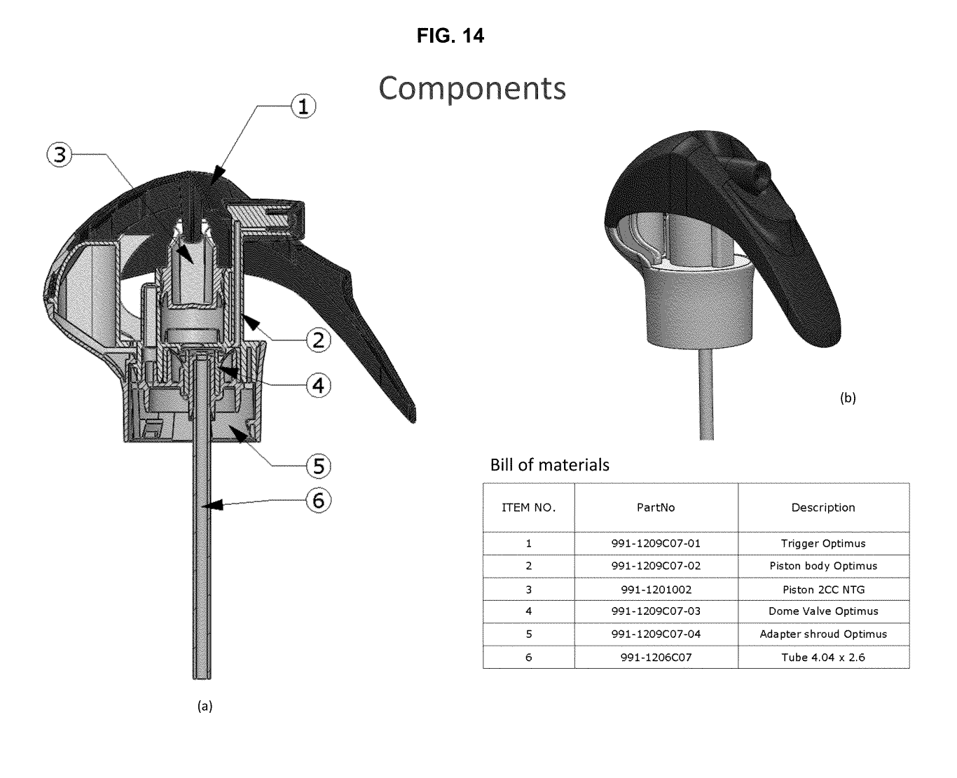

As shown in FIG. 14, an exemplary Optimus sprayer can have six main components, namely, a trigger 1, a piston body 2, a piston 3, a dome valve 4, an adapter shroud 5, and a dip tube 6. An Optimus sprayer, although having a vertically mounted piston, can dispense up to 1.3 per stroke, which is a significant advance over conventional vertically configures sprayers that only dispense on the order of 0.5 cc per stroke.

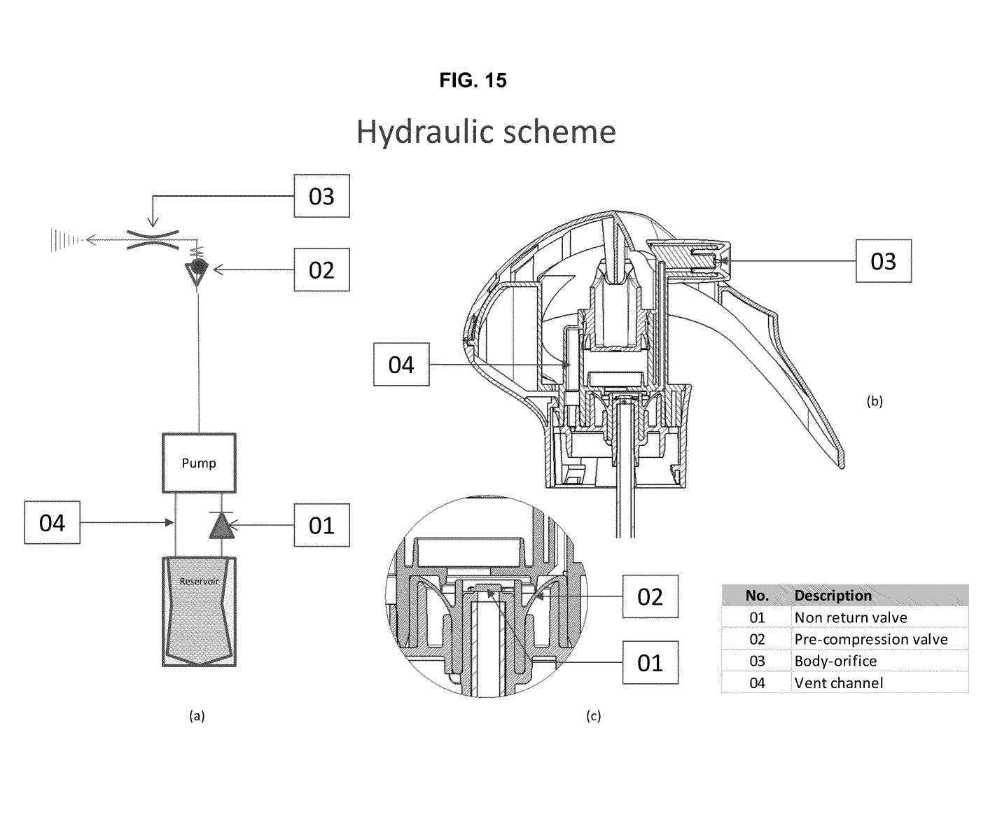

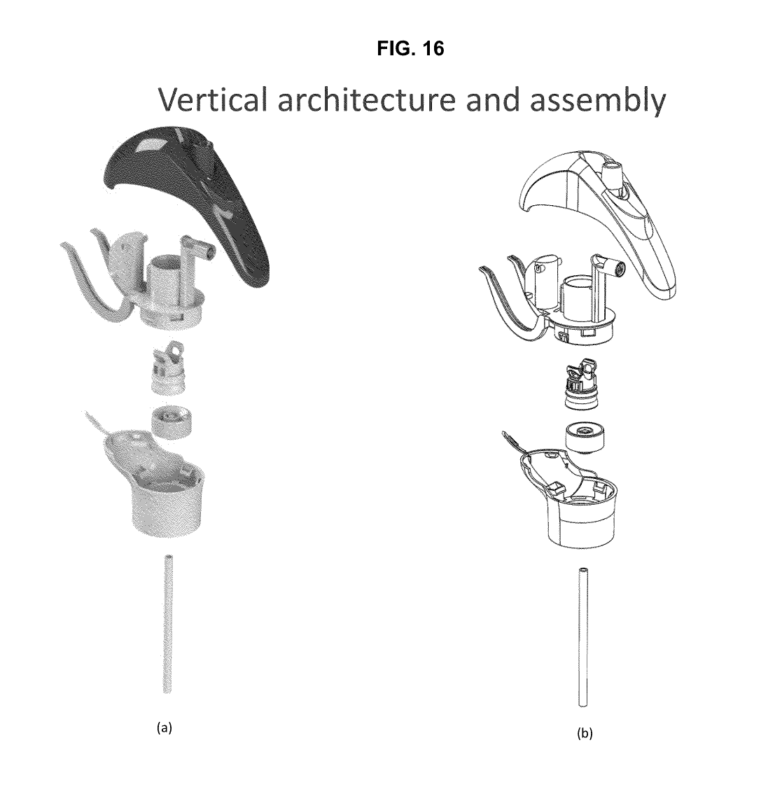

FIG. 15 depicts a hydraulic scheme for the sprayer of FIGS. 12-14. This includes, for example, a non-return valve 1, a precompression valve 2, a body orifice 3, and a vent channel 4. FIG. 16 depicts vertical architecture and assembly of the sprayer of FIGS. 12-14.

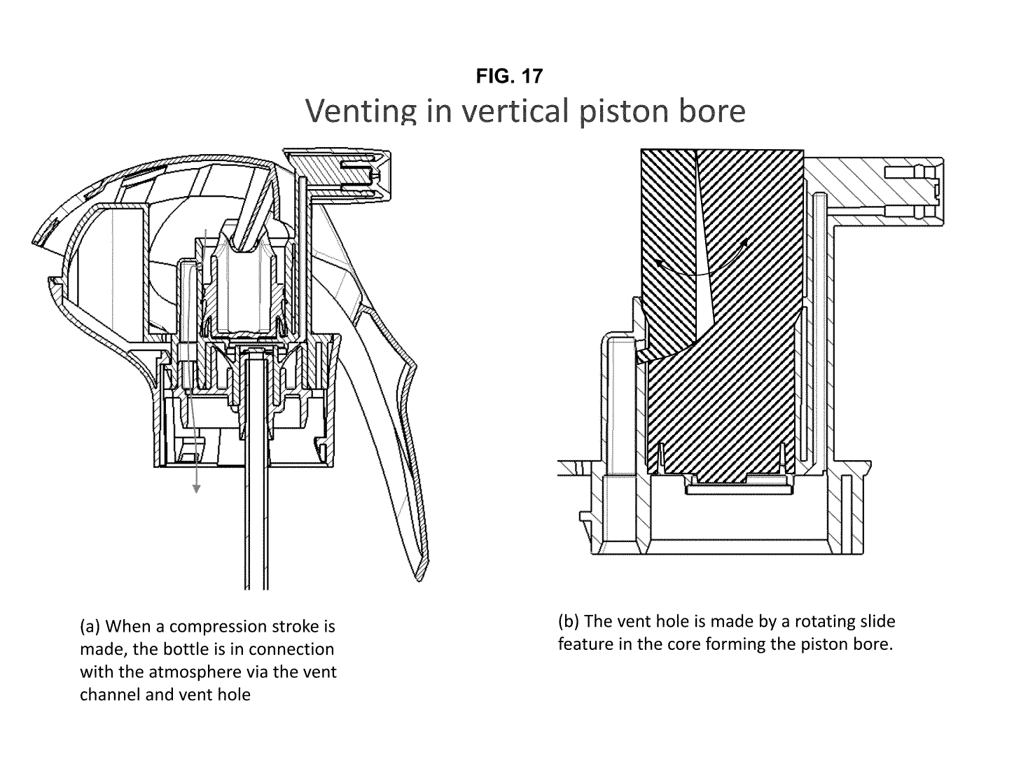

FIG. 17 illustrates a novel venting technique that allows venting via a vertically oriented piston bore. Here as shown on the left, when a compression stroke is made, the bottle is in connection with the atmosphere via the vent channel and vent hole. As shown in the right image, the vent hole is made by a rotating slide feature in the core forming the piston bore.

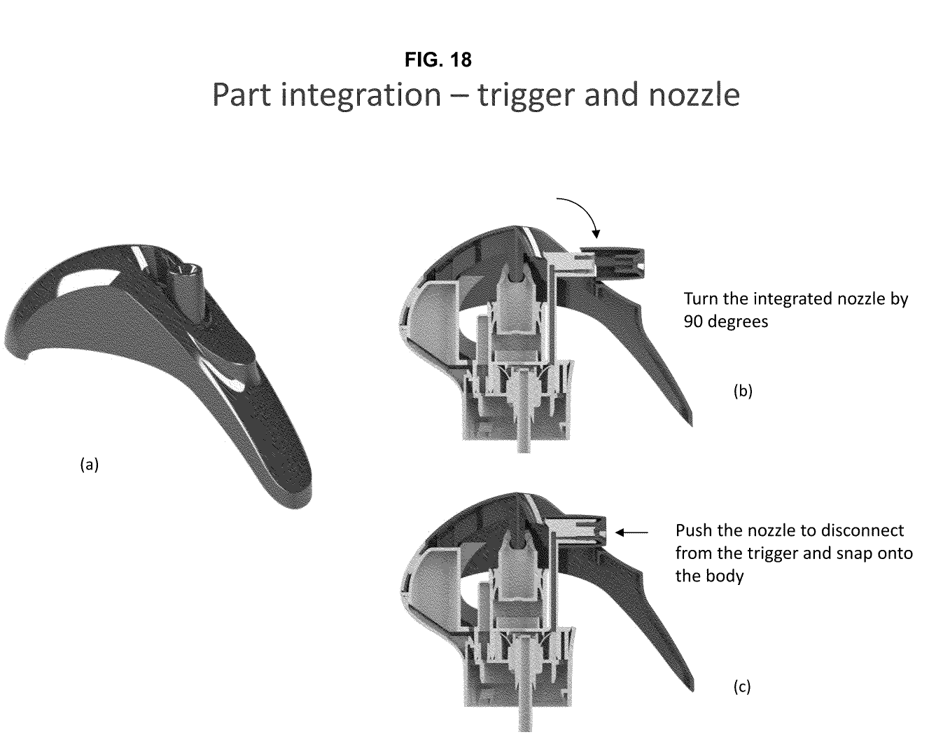

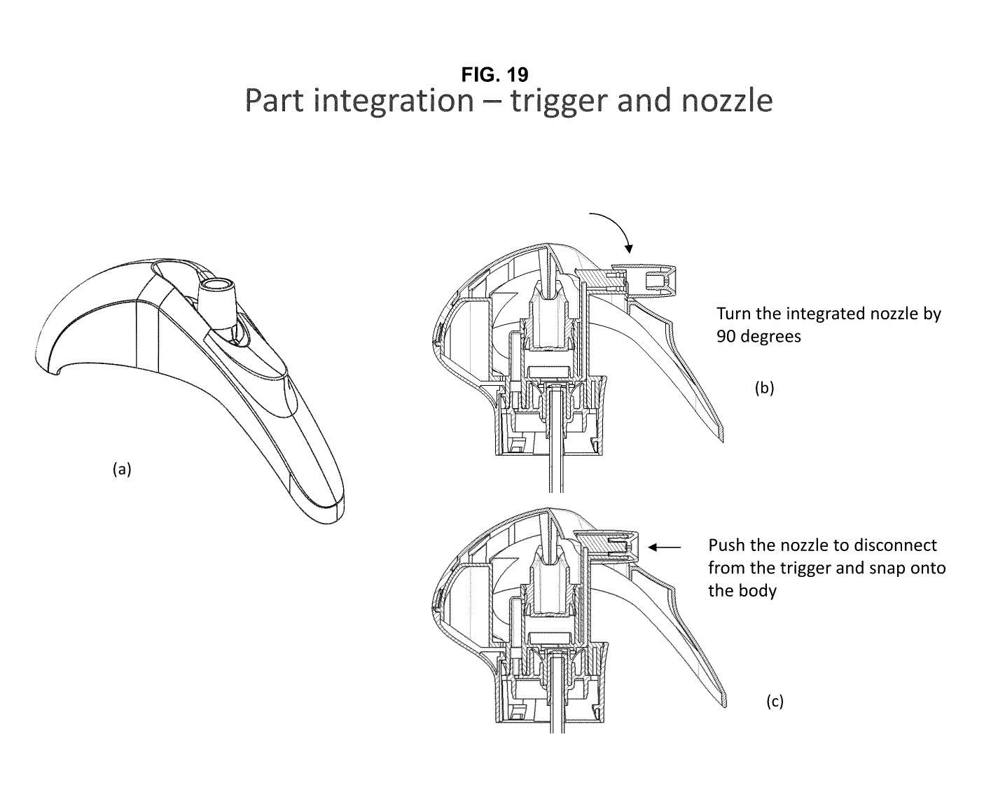

FIGS. 18-24, next described depict part integration in the Optimus sprayer. With reference to FIG. 18, the nozzle is an integrated part of the trigger when injection molded. After being assembled to the body and piston, the nozzle is turned by 90 degrees and pushed to snap onto the body. When snapped to the body, the nozzle is disconnected from the trigger. FIG. 19 is a schematic version of FIG. 18. Thus, the nozzle is provided on the trigger, just waiting for a first use.

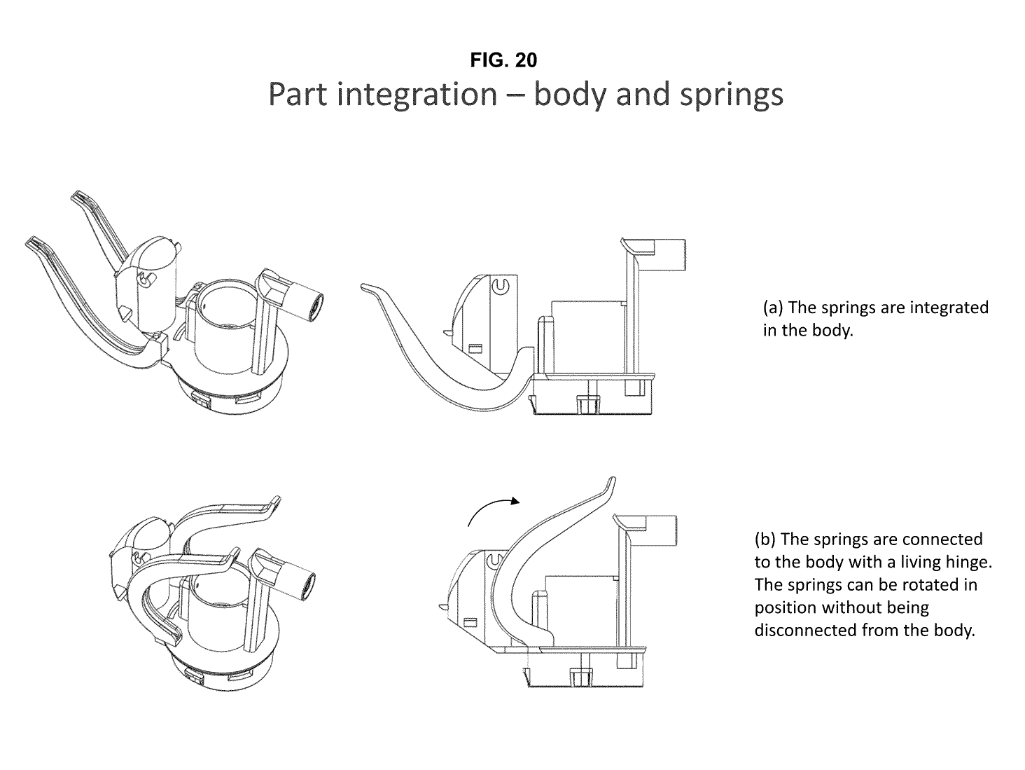

FIG. 20 depicts integration of the sprayer body with the springs. The springs are an integral part of the body when injection molded. During assembly the springs are rotated in position. As shown, first the springs are integrated in the body. Next, the springs are connected to the body with a living hinge. The springs can be rotated in position without being disconnected from the body. The springs bias the trigger to its open position.

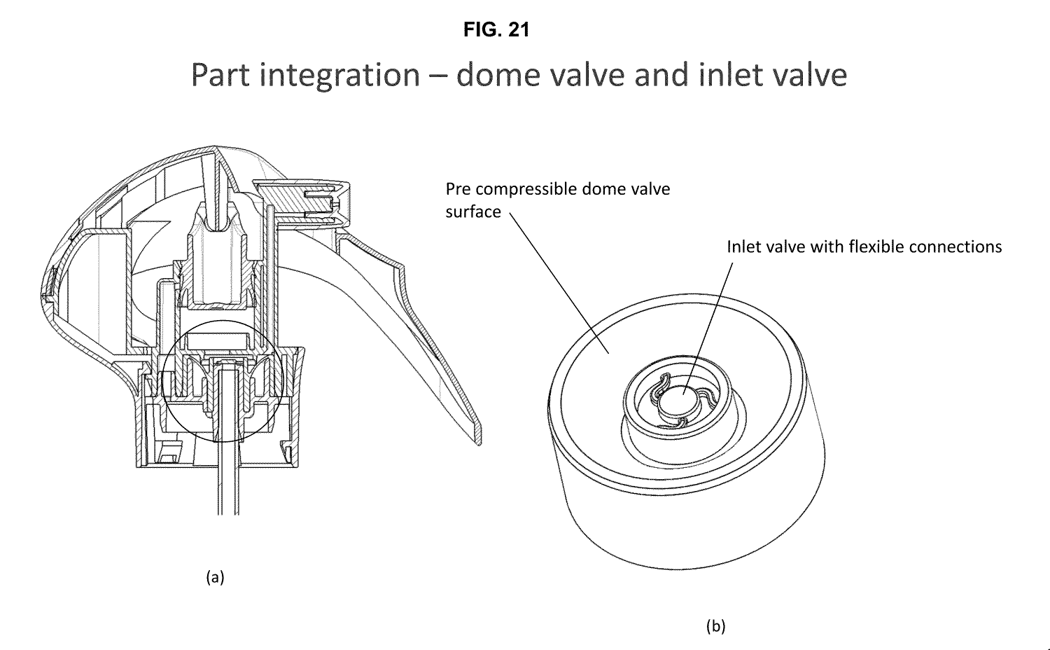

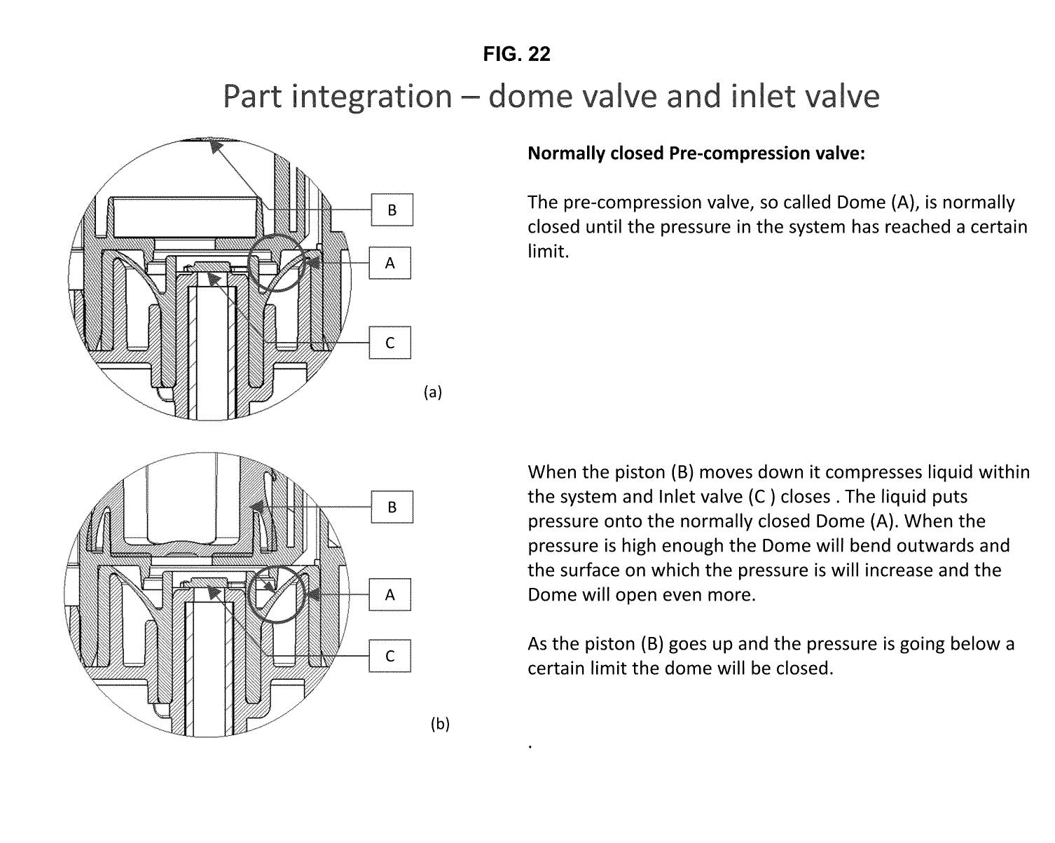

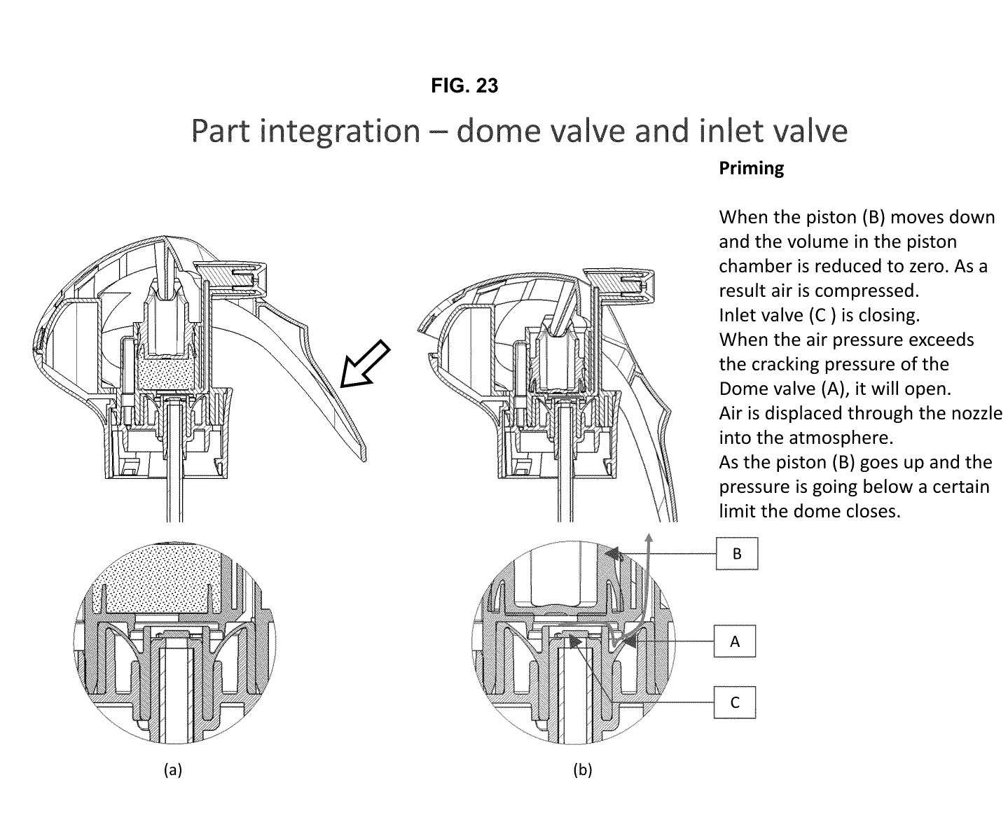

FIG. 21 depicts integration of the dome valve (pre-compression valve) with the inlet valve. This inlet valve is less vulnerable and is more reliable than conventional ones. The operation of this integrated valve is shown in FIGS. 22-23. As shown in FIG. 22, the pre-compression valve, so called Dome (A), is normally closed until the pressure in the system has reached a certain limit. When the piston (B) moves down it compresses liquid within the system and Inlet valve (C) is closing. The liquid is putting pressure onto the normally closed Dome (A). As the pressure is high enough the Dome will bend outwards and the surface on which the pressure is will increase and the Dome will open even more. As the piston (B) goes up and the pressure is going below a certain limit the dome will be closed.

As shown in FIG. 23, for priming, when the piston (B) moves down and the volume in the piston chamber is reduced to zero, as a result air is compressed.

Inlet valve (C) is closing. When the air pressure exceeds the cracking pressure of Dome valve (A), it will open. Air is displaced through the nozzle into the atmosphere. As the piston (B) goes up and the pressure goes below a certain limit, the dome closes.

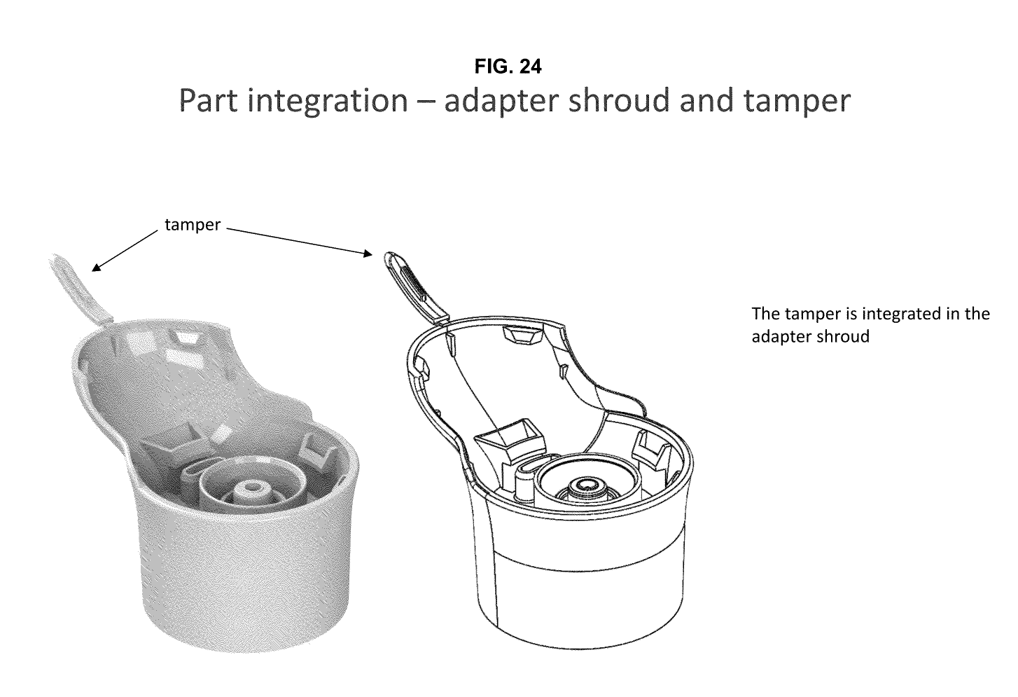

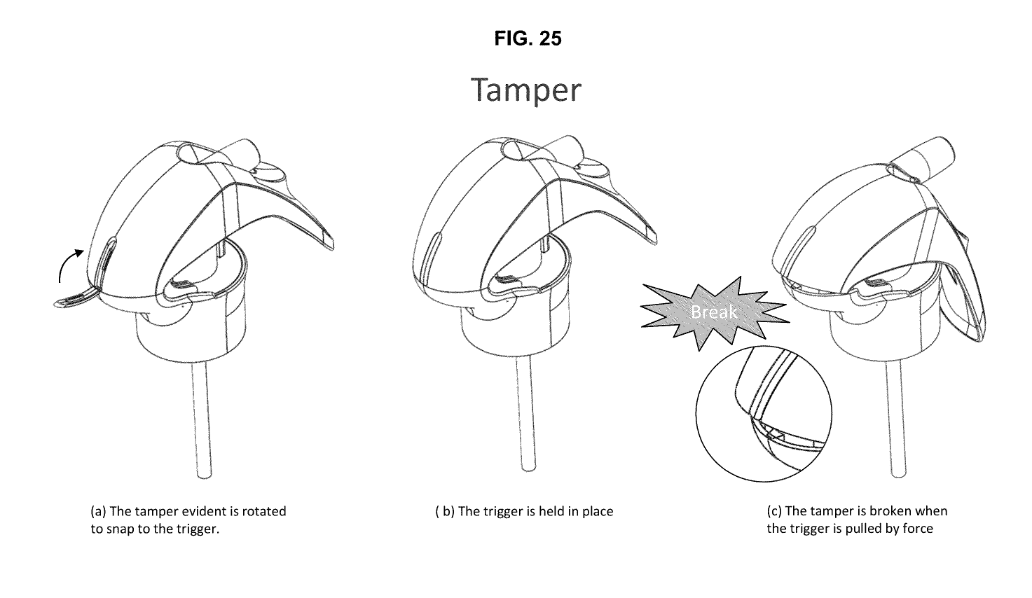

Finally, FIG. 24 illustrates integration of a tamper indication mechanism in the exemplary adapter shroud. As shown in FIG. 25, a tamper-proof feature is integrated in an exemplary adapter shroud. This feature is snap fitted to the trigger.

The trigger is now held in position. Only by pulling the trigger by force, the connection is broken. Thus, this feature: (i) prevents the trigger from being actuated during transport, and (ii) shows a consumer if a product has been tampered with.

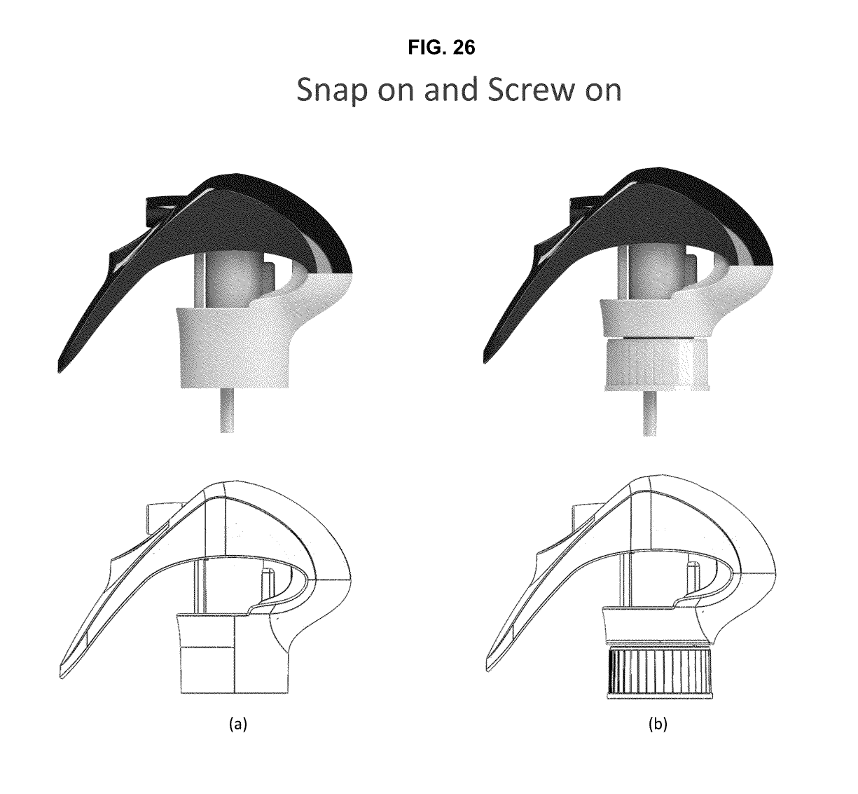

FIG. 26 illustrates various options for fixing a sprayer head to a reservoir bottle. This can be done via a screw cap, a snap on bayonet cap, or via a snap on bayonet cap also provided with a lock-out system.

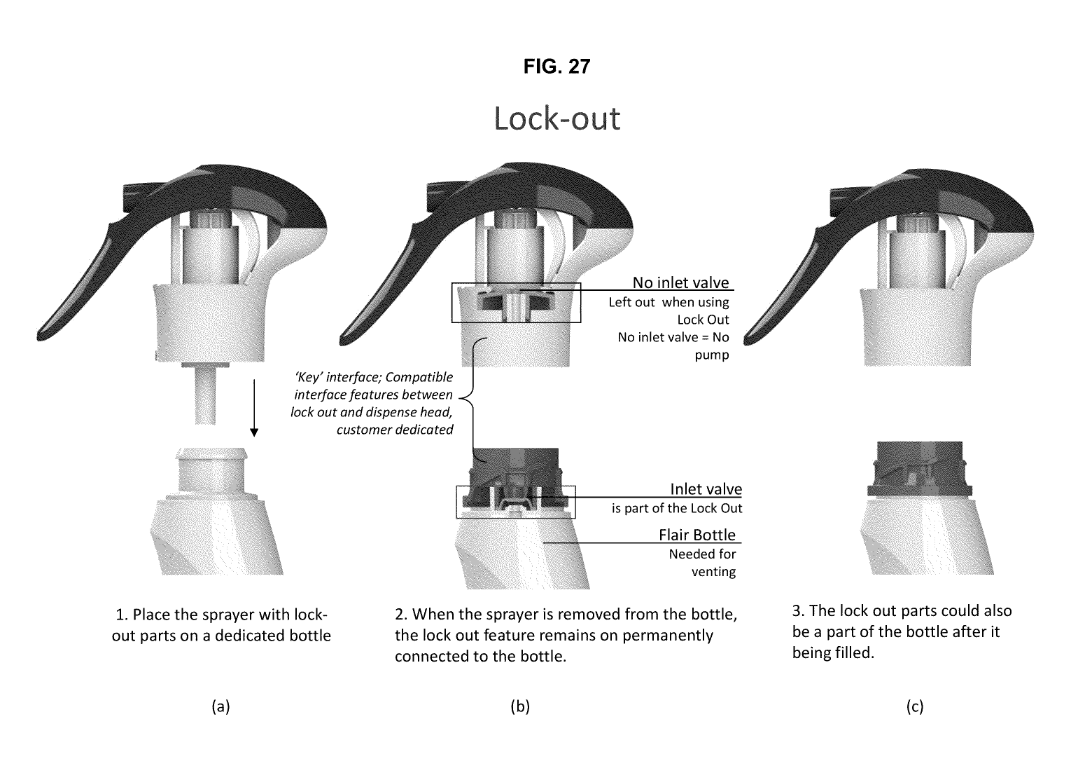

FIG. 27 illustrates further details of an exemplary lock-out mechanism. With reference thereto, when a lock out mechanism is used, there is no inlet valve in a sprayer head. It is integrated into a bottle, as shown. Thus, initially the sprayer with lock-out parts is placed on a dedicated bottle. Then when the sprayer is removed from the bottle, the lock out feature remains permanently connected to the bottle. A sprayer disconnected from the lock out cannot act as a pump, since the inlet valve is part of the lock-out and not of the sprayer. Finally, The lock out parts could also be a part of the bottle after it being filled. In this way the sprayer can be re-used and the bottles can, for example, function as dedicated refills.

### Stretch Molding Technology

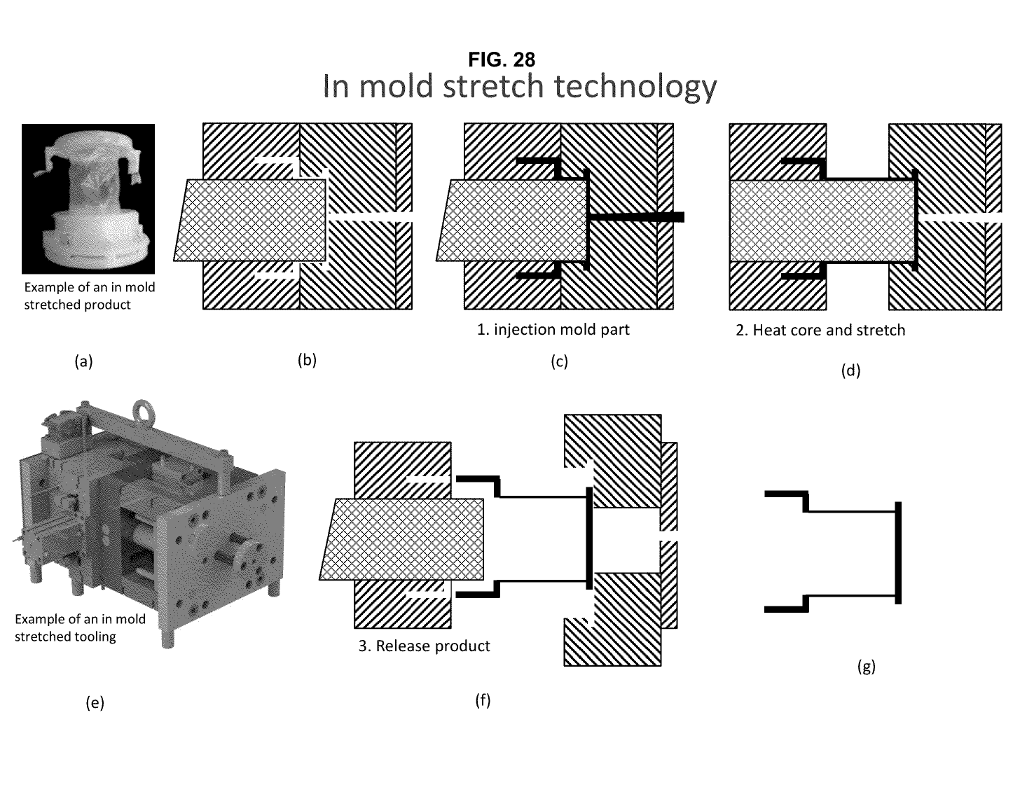

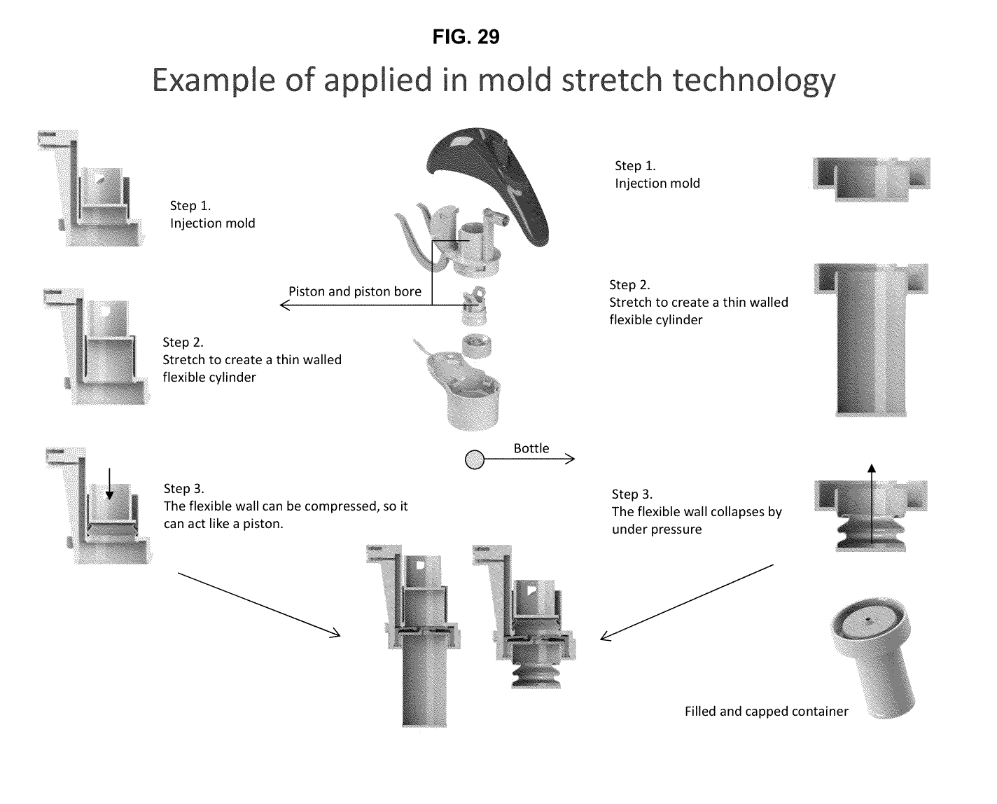

FIGS. 28-29 illustrate a novel in-mold stretch technology and various exemplary uses thereof, according to exemplary embodiments of the present invention. As shown in FIG. 28, first a part is injection molded. Next the core of the mold can be heated, and the molded part stretched. Finally, the molded and now stretched product can be released form the mold. The technology enables the creation of a product with thin walls which cannot be achieved by conventional existing techniques.

For example; a wall of 0.6 mm thickness can be injection molded, by stretching this wall becomes 0.2 mm thick over a longer length. This is not possible with conventional injection molding techniques. This in-mold stretch technology can be applied for various applications such as: a single piece piston in pumps, or thin walled containers which collapse by under pressure, so no venting is needed, as, for example, a diaphragm nozzle.

FIG. 29 illustrates using the in mold stretch technology to fashion a piston bore (left side), and a filled and capped container (right side). By combining both streams of FIG. 29, for example, an exemplary sprayer can be made which is a true airless system. The combined piston/piston bore as shown in the left hand side of FIG. 29 can be fitted with the small filled and capped container shown in the right hand side of FIG. 29.

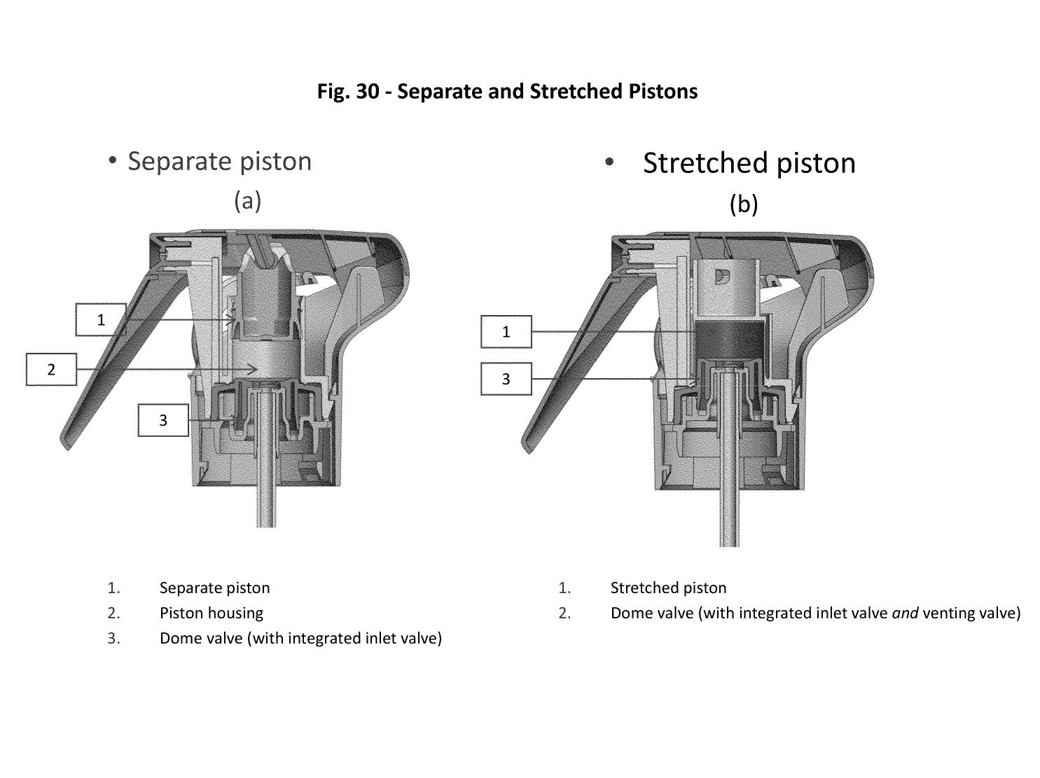

Because in each case of FIG. 29 the end product is a flexible wall, and compressible cylinder, it can serve as a collapsible piston (as shown in FIGS. 30-35 below), or can also serve as a collapsible thin walled container. Such a container can be filled with a liquid, and then caped, leaving effectively no air inside. This creates a mini version of a Flair-type system except that no outer container is needed. Once an under pressure is created within the interior of the filled and capped container by a pumping operation, due to its flexibility it will collapse, just as if it were a Flair-type inner container. Thus, by combining (i) the sprayer of FIG. 29, having the integrated piston and piston bore, with (ii) the filled and capped container of FIG. 29, a “pseudo-Flair” airless dispenser can be created.

The pink disc on top of the filled and capped container see in FIG. 29 functions as both a cap and valve seat for the outlet valve of the Optimus sprayer, as shown.

### Exemplary Stretch Piston for Sprayers

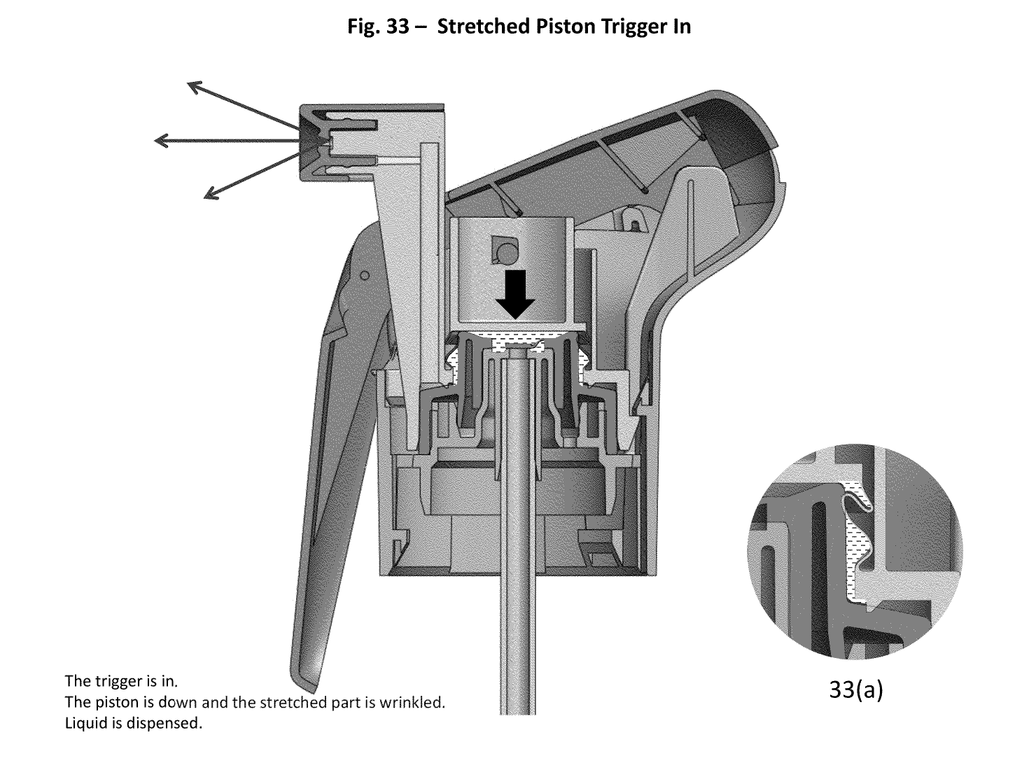

FIG. 30 illustrates side by side comparisons of a sprayer head with a separate and a stretch piston according to exemplary embodiments for the present invention. The separate piston embodiment has been used before, and is illustrated, for example, in U.S. Pat. No. 8,256,648, under common assignment herewith. The stretch piston, shown in FIG. 30(b), illustrates a novel piston type. Unlike the separate piston, which has two parts, the piston and the piston housing, the stretch piston is one integrated part which moves up and down like a bellows, opening and closing the piston chamber. The stretched piston can be made from, for example, polyamides or other thermoplastics, and can be stretched after molding, while the device is still hot, and still in the mold. The stretching aligns the molecules, and thus strengthens them, making the walls of the stretched piston capable of repeated stretching to full length and folding on themselves, as shown in FIG. 33(a).

In exemplary embodiments of the present invention, in order to have the additional functionality of venting, and thus moving venting functionality to the sprayer head, dome valve 3 of the separate piston embodiment has been modified and vertically elongated so as to now have an integrated inlet valve and venting valve according to exemplary stretched piston embodiments of the present invention, as shown in FIG. 30(b). Piston stretching will be described further below, but it is noted that piston stretching is a technology invented for uses involving flexible diaphragm nozzles.

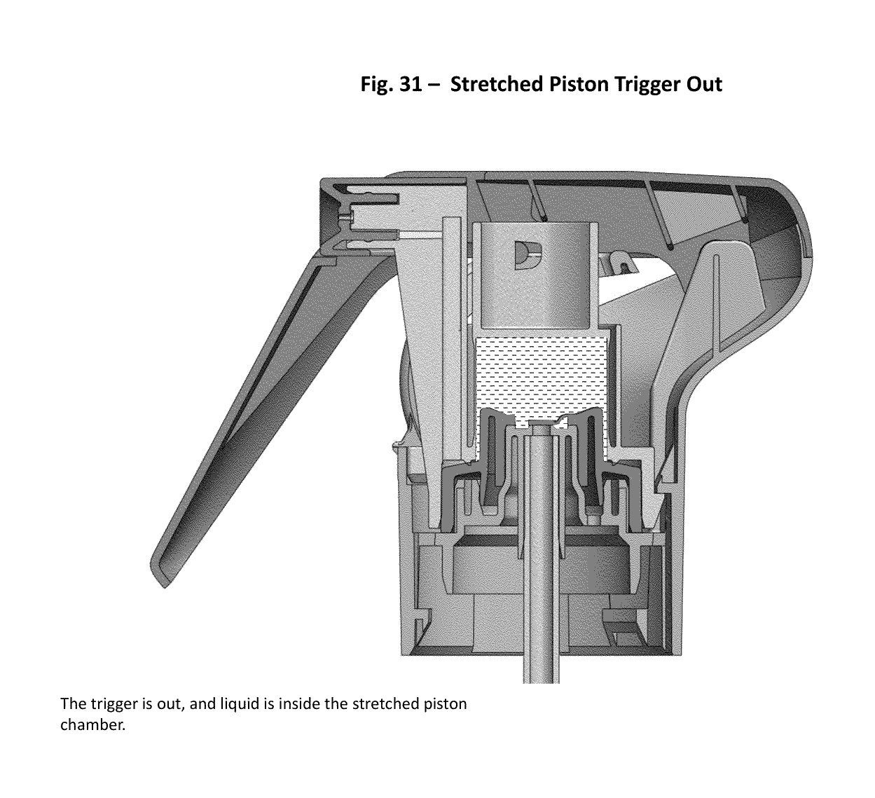

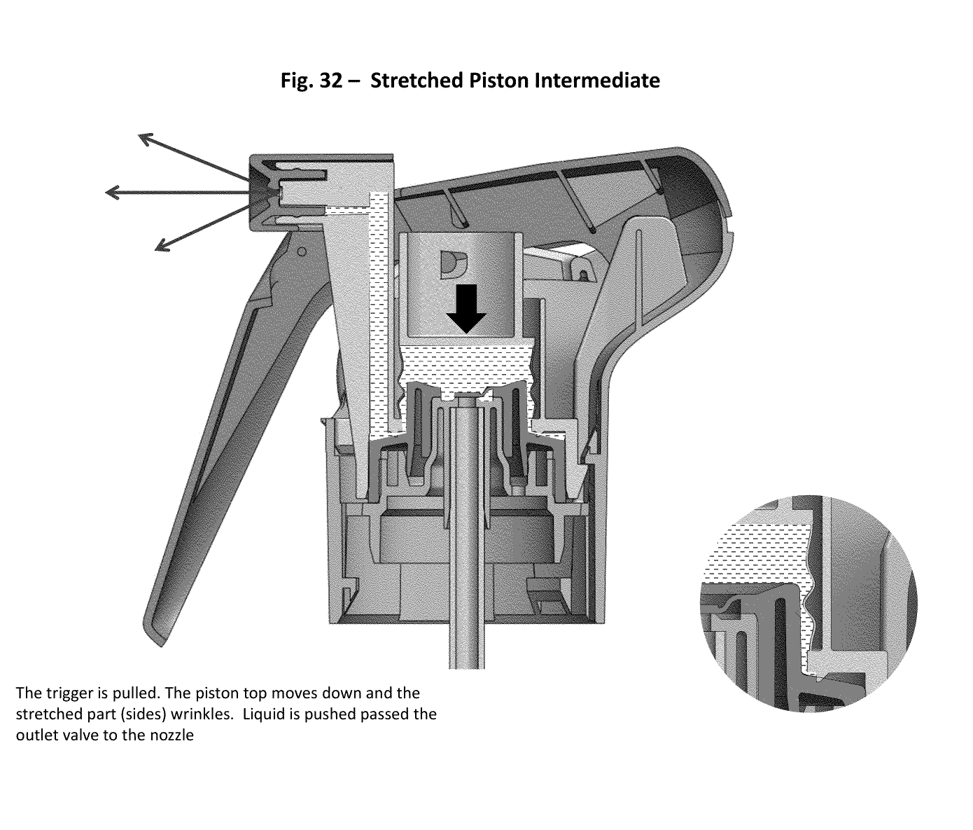

FIGS. 31-33 show intermediate positions as a user pulls on the trigger and closes the piston chamber of the stretch piston sprayer head shown in FIG. 30. With reference thereto, in FIG. 31 the trigger is all the way out, not moved by the user whatsoever. As a result, the piston chamber is at its largest volume, with the piston at its uppermost position. In this configuration the piston chamber is full of liquid. Continuing with reference to FIG. 32, as a user pulls the trigger the piston is moved downwards. The stretched part of the piston which comprises the cylindrical walls of the piston chamber begins to wrinkle as in a bellows, and liquid is pushed past the outlet valve of dome valve 2 to the nozzle and out in a spray. Finally, FIG. 33 shows the configuration where the user has pulled the trigger all the way back, and the piston chamber is now completely closed with the bottom of the piston abutting against the top of the dome valve. The sides of the stretched piston are completely wrinkled as shown in FIG. 33(a), and the rest of the liquid is dispensed out the nozzle.

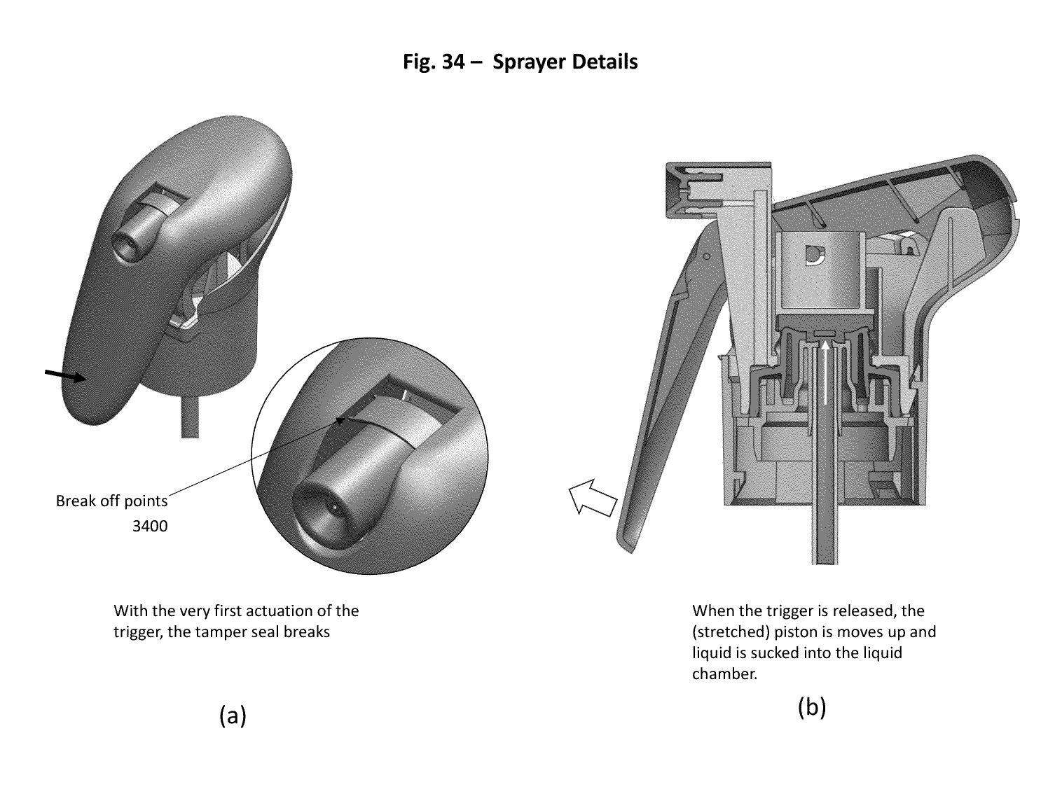

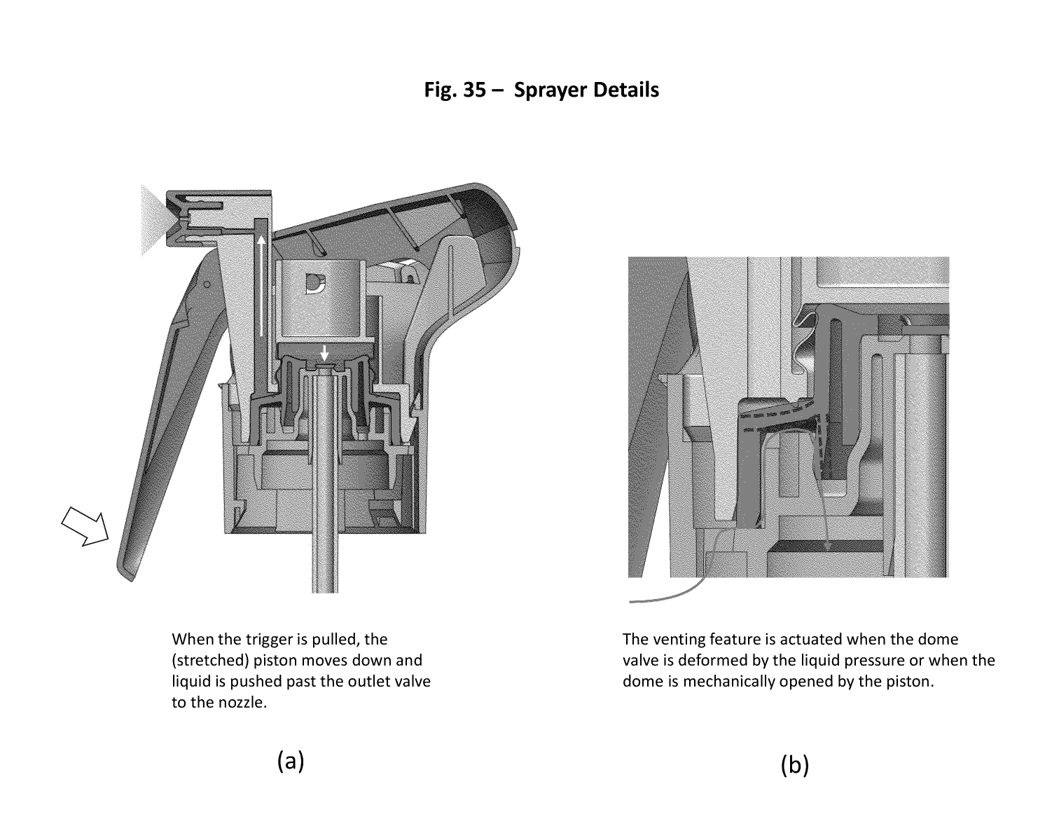

FIGS. 34 and 35, next described, provide various details of the stretched piston sprayer shown, for example, in FIG. 30(b).

### Details of Stretched Piston Sprayers

FIG. 34 shows additional sprayer details, especially break-off points 3400. When a user first actuates the trigger, the tamper seal breaks off. As shown in FIG. 34(b), when the trigger is released the stretch piston moves upward and liquid is, thereby sucked into the liquid chamber through the inlet valve. FIG. 35 shows details of the venting system. Thus, in FIG. 35(a), when the trigger is pulled, the stretch piston moves down and liquid is pushed past the outlet valve to the nozzle. In FIG. 35(a), the outlet valve is incorporated in the dome valve. With reference to FIG. 35(b), the venting feature of the novel dome valve is actuated when the dome valve is deformed by liquid pressure or when the dome is mechanically opened by the piston, such as in an initial priming stroke. Finally, it is noted that FIG. 35(b) also shows detail of the side of the stretch piston in the fully compressed state of the piston chamber. Here, the walls of the piston chamber are now folded on themselves in a wrinkled manner. Because of their flexibility and ability to be wrinkled in this manner, the stretch piston can operate as an integrated device, not requiring a piston chamber in which a separate piston moves up and down as in, for example, the case of FIG. 30(a).

The above-presented description and figures are intended by way of example only and are not intended to limit the present invention in any way except as set forth in the following claims. It is particularly noted that the persons skilled in the art can readily combine the various technical aspects of the various exemplary embodiments described.

1. A liquid dispensing device, comprising:
a dispensing head,
said dispensing head comprising:
an inlet valve,
a piston and a piston chamber,
an outlet valve in fluid communication with the piston chamber; and
a nozzle,
wherein the piston chamber is mounted vertically, and has a volume greater than 1.0 cc.

2. The liquid dispensing device of claim 1, wherein one of:
the piston and piston chamber are integrated in a single part;
the piston and piston chamber are integrated in a single part, and
the integrated piston and piston chamber are made by in-line stretch molding; and
the piston and piston chamber are integrated in a single part, the integrated piston and piston chamber are made by in-line stretch molding, and first a cylindrical piston bore with attached piston is injection molded, and then the cylindrical bore is stretched, while in the mold, to create a compressible cylinder.

3-4. (canceled)

5. The liquid dispensing device of claim 1, further comprising a trigger arranged to actuate the piston and a tube, and wherein the total part count is no more than six parts.

6. The liquid dispensing device of claim 5, wherein an inlet valve is integrated with the outlet valve, and said six parts comprise: a trigger, a piston body, a piston, an outlet valve, an adapter shroud, and a tube.

7. The liquid dispensing device of claim 1, wherein the piston and piston chamber are integrated in a single part, and further comprising a trigger arranged to actuate the piston and a tube, and wherein the total part count is no more than five parts.

8. The liquid dispensing device of claim 7, wherein said five parts comprise: a trigger, a combination piston and piston chamber, an outlet valve, an adapter shroud, and a tube.

9. The liquid dispensing device of claim 1, wherein the piston chamber is vented via a vent hole in an upper portion of the piston bore and via a side channel mounted parallel to the piston bore and extending downwards into an interface for a bottle.

10. The liquid dispensing device of claim 9, wherein the vent hole in the piston bore is made by a rotating slide feature in a core used to form the piston bore.

11. The liquid dispensing device of claim 1, wherein at least one of:
the outlet valve is a plastic dome valve;
the outlet valve is a plastic dome valve, wherein the plastic dome valve incorporates the inlet valve; and
the dispensing head includes an adapter shroud; and
the dispensing head includes an adapter shroud, wherein the adapter shroud incorporates a tamper indicator device.

12-14. (canceled)

15. The liquid dispensing device of claim 1, wherein the nozzle is integrated with a trigger.

16. The liquid dispensing device of claim 15, wherein the nozzle is an integrated part of the trigger when injection molded, but then, when attached to the sprayer body, is disconnected from the trigger.

17. A method of creating small flexible containers, comprising:
injection molding a first part, said part comprising a tubular structure;
while still in the mold, stretching a portion of the tubular structure to form a flexible portion of the tubular structure.

18. The method of claim 17, further comprising filling the tubular structure and capping it.

19. The method of claim 17, wherein the tubular structure is used as an integrated piston and piston bore in a sprayer.

20. The method of claim 1, further comprising an adapter shroud, wherein the adapter shroud further comprises an interface designed to mate with a lock out interface on a bottle.

21. A method of controlling access to sprayer bottles, comprising:
providing a set of sprayers;
for each sprayer in the set,
providing a unique geometry on the interface between the sprayer body and a bottle containing liquid to be dispensed from the sprayer;
providing a lock out interface on a set of bottles associated with the sprayer; and
for each bottle in the set of bottles, providing a complementary geometry on a lock out interface integrated with the bottle, the complementary geometry allowing the setoff bottles to attach to the sprayer.

22. The method of claim 21, wherein the unique geometry has variation in one or more of depth, height, diameter, and interlocking ribs and corresponding holes of each of the interface on the sprayer body and the complementary geometry on the bottles.

23. The method of claim 22, wherein an inlet valve is integrated in the lock out interface in each bottle.

24. The liquid dispensing device of claim 1, wherein at least one of the following sets of parts are integrated in the device: trigger and nozzle, body and springs, dome valve and inlet valve, and adapter shroud and tamper.

25. The liquid dispensing device of claim 1, wherein all of the following sets of parts are integrated in the device: trigger and nozzle, body and springs, dome valve and inlet valve, and adapter shroud and tamper.
